(19) United States
(12) Patent Application Publication
(10) Pub. No.: US 2023/0246226 A1
(43) Pub. Date: Aug. 3, 2023

(54) INORGANIC SOLID ELECTROLYTE-CONTAINING COMPOSITION, SHEET FOR ALL-SOLID STATE SECONDARY BATTERY, AND ALL-SOLID STATE SECONDARY BATTERY, AND MANUFACTURING METHODS FOR SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Shota OI, Kanagawa (JP); Yo KUSHIDA, Kanagawa (JP)

(73) Assignee: FUJIFILM Corporation, Tokyo (JP)

(21) Appl. No.: 18/180,129

(22) Filed: Mar. 8, 2023

Related U.S. Application Data
(63) Continuation of application No. PCT/JP2021/032905, filed on Sep. 7, 2021.

(30) Foreign Application Priority Data
Sep. 16, 2020 (JP) 2020-155492

(51) Int. Cl. H01M 10/056; H01M 10/0525

(52) U.S. Cl. CPC H01M 10/056; H01M 10/0525; H01M 2300/0091; H01M 2300/0071; H01M 2300/008

(57) ABSTRACT

There are provided an inorganic solid electrolyte-containing composition that exhibits excellent dispersibility and hardly deteriorates an inorganic solid electrolyte and is capable of forming a constitutional layer that exhibits a high ion conductivity even in a low temperature environment, a sheet for an all-solid state secondary battery and an all-solid state secondary battery, in which this inorganic solid electrolyte-containing composition is used, and manufacturing methods for a sheet for an all-solid state secondary battery and an all-solid state secondary battery. The inorganic solid electrolyte-containing composition contains an inorganic solid electrolyte, a polymer binder, and a dispersion medium, in which the polymer binder contains a polymer having a surface energy of 20 mN/m or less and an SP value of 14 to 21.5 MPa^{1/2}, and the polymer binder is dissolved in the dispersion medium.

### CROSS-REFERENCE TO RELATED APPLICATIONS

This application is a Continuation of PCT International Application No. PCT/JP2021/032905 filed on Sep. 7, 2021, which claims priority under 35 U.S.C. § 119 (a) to Japanese Patent Application No. 2020-155492 filed in Japan on Sep. 16, 2020. Each of the above applications is hereby expressly incorporated by reference, in its entirety, into the present application.

### BACKGROUND OF THE INVENTION

### 1. Field of the Invention

The present invention relates to an inorganic solid electrolyte-containing composition, a sheet for an all-solid state secondary battery, and an all-solid state secondary battery, and manufacturing methods for a sheet for an all-solid state secondary battery and an all-solid state secondary battery.

### 2. Description of the Related Art

In an all-solid state secondary battery, all of a negative electrode, an electrolyte, and a positive electrode consist of solid, and the all-solid state secondary battery can greatly improve safety and reliability, which are said to be problems to be solved in a battery in which an organic electrolytic solution is used. It is also said to be capable of extending the battery life. Furthermore, all-solid state secondary batteries can be including a structure in which the electrodes and the electrolyte are directly disposed in series. As a result, it becomes possible to increase the energy density to be high as compared with a secondary battery in which an organic electrolytic solution is used, and thus the application to electric vehicles, large-sized storage batteries, and the like is anticipated.

In such an all-solid state secondary battery, as substances that form constitutional layers (a solid electrolyte layer, a negative electrode active material layer, a positive electrode active material layer, and the like), solid materials such as an inorganic solid electrolyte and an active material are used. In recent years, this inorganic solid electrolyte, particularly an oxide-based inorganic solid electrolyte or a sulfide-based inorganic solid electrolyte is expected as an electrolyte material having a high ion conductivity comparable to that of the organic electrolytic solution.

However, in the constitutional layer composed of solid particles such as an inorganic solid electrolyte, an active material, and a conductive auxiliary agent, the interfacial contact state between the solid particles is restricted, and thus the interface resistance tends to increase (the decrease in ion conductivity) even in a case where the material itself exhibits a high ion conductivity. Moreover, in an all-solid state secondary battery including such a constitutional layer, the energy loss becomes large, and the cycle characteristics are deteriorated in a case where the battery is repeatedly charged and discharged.

In order to suppress such an increase in interface resistance, in addition to the above-described inorganic solid electrolyte, dispersion medium, and the like, a composition containing a particle-shaped polymer binder has been proposed as a material (a constitutional layer forming material) for forming a constitutional layer of an all-solid state secondary battery. For example, WO2017/099247A1 discloses a solid electrolyte composition containing an inorganic solid electrolyte having an ion conductivity of a metal element belonging to Group 1 or Group 2 in the periodic table, binder particles having an average particle diameter of 10 nm or more and 50,000 nm or less, which contain a polymer having an SP value of 10.5 cal^{1/2} cm^{-3/2} or more, and a dispersion medium.

### SUMMARY OF THE INVENTION

From the viewpoint of the improvement of the battery performance (for example, ion conductivity and cycle characteristics) and the like, a constitutional layer forming material for an all-solid state secondary battery is required to have solid particles which are highly dispersed in a dispersion medium.

Moreover, in recent years, the development for practical use of an all-solid state secondary battery has been rapidly progressing, and measures corresponding to this progress have been required. For example, considering the expansion of use applications of an all-solid state secondary battery, it is required to maintain a high ion conductivity not only in a normal temperature environment (for example, 15° C. to 35° C.) but also in a low temperature environment of, for example, 5° C. or lower. Further, the inorganic solid electrolyte has a unique problem in that it is easily deteriorated (decomposed) by water. In particular, from the viewpoint of industrial manufacturing, it is an important issue to suppress the deterioration during the manufacturing process. However, it is difficult to completely remove moisture in an environment including a manufacturing atmosphere even in consideration of the scale of the industrial manufacturing equipment and the like, and studies are required from the viewpoints of the constitutional layer forming material and the like.

An object of the present invention is to provide an inorganic solid electrolyte-containing composition that exhibits excellent dispersibility and hardly deteriorates an inorganic solid electrolyte, the inorganic solid electrolyte-containing composition being capable of forming a constitutional layer that exhibits a high ion conductivity even in a low temperature environment. In addition, another object of the present invention is to provide a sheet for an all-solid state secondary battery as well as an all-solid state secondary battery, which include a constitutional layer formed of this inorganic solid electrolyte-containing composition, and manufacturing methods for a sheet for an all-solid state secondary battery and an all-solid state secondary battery, in which the above-described inorganic solid electrolyte-containing composition is used.

From the above-described viewpoints, the inventors of the present invention repeatedly carried out studies on a polymer binder in which an inorganic solid electrolyte and a dispersion medium were used in combination and as a result found that in a case of imparting a characteristic of being dissolved in a dispersion medium to a polymer binder instead of dispersing the polymer binder in a dispersion medium to have a particle shape, and furthermore, forming the polymer binder by using a polymer having a surface energy of 20 mN/m or less and an SP value of 14 to 21.5 MPa^{1/2}, it is possible to suppress the deterioration of the inorganic solid electrolyte due to moisture while improving the dispersibility of solid particles such as the inorganic solid electrolyte. In addition, it was found that in a case where this inorganic solid electrolyte-containing composition containing this specific polymer binder, inorganic solid electrolyte, and dispersion medium, is used as a constitutional layer forming material, it is possible to realize a sheet for an all-solid state secondary battery, having a constitutional layer which has low resistance and hardly deteriorates even in a low temperature environment, as well as an all-solid state secondary battery having low resistance and excellent cycle characteristics as well even in a low temperature environment. The present invention has been completed through further studies based on these findings.

That is, the above problems have been solved by the following means.

<1> An inorganic solid electrolyte-containing composition comprising:

an inorganic solid electrolyte having an ion conductivity of a metal belonging to Group 1 or Group 2 in the periodic table;

a polymer binder; and

a dispersion medium,

in which the polymer binder contains a polymer having a surface energy of 20 mN/m or less and an SP value of 14 to 21.5 MPa^{1/2} and is dissolved in the dispersion medium.

<2> The inorganic solid electrolyte-containing composition according to <1>, in which the polymer has an elastic modulus of 1 MPa or more.

<3> The inorganic solid electrolyte-containing composition according to <1> or <2>, in which the polymer has a constitutional component represented by Formula (LF) or Formula (LS) in a main chain or a side chain,

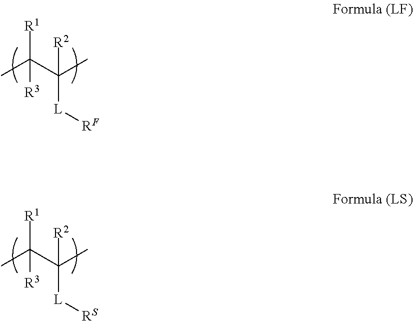

in Formula (LF) or Formula (LS), R¹ to R³ represent a hydrogen atom or a substituent,

L represents a single bond or a linking group,

R^{F} represents a substituent containing a carbon atom and a fluorine atom, and

R^{S} represents a substituent containing a silicon atom.

<4> The inorganic solid electrolyte-containing composition according to any one of <1> to <3>, in which the polymer is a graft polymer.

<5> The inorganic solid electrolyte-containing composition according to any one of <1> to <3>, in which a main chain of the polymer is a block polymer.

<6> The inorganic solid electrolyte-containing composition according to any one of <1> to <5>, in which the dispersion medium has an SP value of 14 to 24 MPa^{1/2}.

<7> The inorganic solid electrolyte-containing composition according to any one of <1> to <6>, further comprising an active material.

<8> The inorganic solid electrolyte-containing composition according to any one of <1> to <7>, further comprising a conductive auxiliary agent.

<9> The inorganic solid electrolyte-containing composition according to any one of <1> to <8>, in which the inorganic solid electrolyte is a sulfide-based inorganic solid electrolyte.

<10> A sheet for an all-solid state secondary battery, comprising a layer formed of the inorganic solid electrolyte-containing composition according to any one of <1> to <9>.

<11> An all-solid state secondary battery comprising, in the following order:

a positive electrode active material layer;

a solid electrolyte layer; and

a negative electrode active material layer,

in which at least one of the positive electrode active material layer, the solid electrolyte layer, or the negative electrode active material layer is a layer formed of the inorganic solid electrolyte-containing composition according to any one of <1> to <9>.

<12> A manufacturing method for a sheet for an all-solid state secondary battery, the manufacturing method comprising forming a film of the inorganic solid electrolyte-containing composition according to any one of <1> to <9>.

<13> A manufacturing method for an all-solid state secondary battery, comprising manufacturing an all-solid state secondary battery through the manufacturing method according to <12>.

According to the present invention, it is possible to provide an inorganic solid electrolyte-containing composition that exhibits excellent dispersibility and can suppress the deterioration of an inorganic solid electrolyte, the inorganic solid electrolyte-containing composition being capable of forming a constitutional layer that exhibits a high ion conductivity even in a low temperature environment. In addition, according to the present invention, it is possible to provide a sheet for an all-solid state secondary battery and an all-solid state secondary battery, which have a layer formed of the above inorganic solid electrolyte-containing composition. Further, according to the present invention, it is possible to provide manufacturing methods for a sheet for an all-solid state secondary battery and an all-solid state secondary battery, in which the above inorganic solid electrolyte-containing composition is used.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating a coin-type all-solid state secondary battery prepared in Examples.

### DESCRIPTION OF THE PREFERRED EMBODIMENTS

In the present invention, a numerical range indicated using “to” means a range including numerical values before and after the “to” as the lower limit value and the upper limit value.

In the present invention, the expression of a compound (for example, in a case where a compound is represented by an expression in which “compound” is attached to the end) refers to not only the compound itself but also a salt or an ion thereof. In addition, this expression also refers to a derivative obtained by modifying a part of the compound, for example, by introducing a substituent into the compound within a range where the effect of the present invention is not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same shall be applied to a compound that is not specified in the present specification regarding whether to be substituted or unsubstituted. Examples of the preferred examples of the substituent include a substituent Z described later.

In the present invention, in a case where a plurality of substituents or the like represented by a specific reference numeral are present or a plurality of substituents or the like are simultaneously or alternatively defined, the respective substituents or the like may be the same or different from each other. In addition, unless specified otherwise, in a case where a plurality of substituents or the like are adjacent to each other, the substituents may be linked or fused to each other to form a ring.

In the present invention, the polymer means a polymer; however, it is synonymous with a so-called polymeric compound. Further, a polymer binder means a binder constituted of a polymer and includes a polymer itself and a binder formed by containing a polymer.

[Inorganic Solid Electrolyte-Containing Composition]

The inorganic solid electrolyte-containing composition according to the embodiment of the present invention contains an inorganic solid electrolyte having an ion conductivity of a metal belonging to Group 1 or Group 2 in the periodic table; a polymer binder composed by containing a polymer that exhibits specific characteristics or physical properties described later; and a dispersion medium. This polymer binder has a characteristic (solubility) of being soluble in a dispersion medium contained in the inorganic solid electrolyte-containing composition. The polymer binder in the inorganic solid electrolyte-containing composition generally is present in a state of being dissolved in a dispersion medium in the inorganic solid electrolyte-containing composition, which depends on the content thereof. Accordingly, the polymer binder functions to disperse solid particles in the dispersion medium, and the dispersibility of the solid particles in the inorganic solid electrolyte-containing composition can be improved. Further, the adhesiveness between the solid particles or to the collector is strengthened, and thus it is possible to further enhance the effect of improving the cycle characteristics of the all-solid state secondary battery.

In the present invention, the description that a polymer binder is dissolved in a dispersion medium in an inorganic solid electrolyte-containing composition is not limited to an aspect in which the entire polymer binder is dissolved in the dispersion medium, and for example, a part of the polymer binder may be present in an insoluble form in the inorganic solid electrolyte-containing composition as long as the following solubility in a dispersion medium is 80% or more.

In addition, the description that a polymer binder is dissolved in a dispersion medium refers to that the solubility of the polymer binder in the dispersion medium is 80% or more.

The measuring method for solubility is as follows. That is, a specified amount of a polymer binder as a measurement target is weighed in a glass bottle, 100 g of a dispersion medium that is the same kind as the dispersion medium contained in the inorganic solid electrolyte-containing composition is added thereto, and stirring is carried out at a temperature of 25° C. on a mix rotor at a rotation speed of 80 rpm for 24 hours. After stirring for 24 hours, the obtained mixed solution is subjected to the transmittance measurement under the following conditions. This test (the transmittance measurement) is carried out by changing the amount of the binder dissolved (the above-described specified amount), and the upper limit concentration X (% by mass) at which the transmittance is 99.8% is defined as the solubility of the binder in the above dispersion medium.

<Transmittance Measurement Conditions>

Dynamic light scattering (DLS) measurement

Device: DLS measuring device DLS-8000 manufactured by Otsuka Electronics Co., Ltd.

Laser wavelength, output: 488 nm/100 mW

Sample cell: NMR tube

It suffices that the inorganic solid electrolyte-containing composition according to the embodiment of the present invention contains the polymer binder, and the existence state of the polymer binder and the like are not particularly limited and may be or may not be adsorbed to the inorganic solid electrolyte.

This polymer binder functions, in a constitutional layer formed of at least an inorganic solid electrolyte-containing composition, as a binder that causes solid particles of an inorganic solid electrolyte (as well as a co-existable active material, conductive auxiliary agent, and the like) or the like to mutually binds therebetween (for example, between solid particles of an inorganic solid electrolyte, solid particles of an inorganic solid electrolyte and an active material, or solid particles of an active material). Further, it may function as a binder that binds a collector to solid particles. In the inorganic solid electrolyte-containing composition, the polymer binder may have or may not have a function of causing solid particles to mutually bind therebetween.

The inorganic solid electrolyte-containing composition according to the embodiment of the present invention is preferably a slurry in which the inorganic solid electrolyte is dispersed in a dispersion medium. In this case, the polymer binder preferably has a function of dispersing solid particles in the dispersion medium.

The inorganic solid electrolyte-containing composition according to the embodiment of the present invention has excellent dispersibility, and thus the inorganic solid electrolyte is less likely to deteriorate. In a case where this inorganic solid electrolyte-containing composition is used as a constitutional layer forming material, it is possible to exhibit a high ion conductivity in the constitutional layer even in a low temperature environment while suppressing deterioration of the inorganic solid electrolyte due to moisture, and it is possible to realize an all-solid state secondary battery having low resistance and excellent cycle characteristics even in a low temperature environment.

In the aspect in which the active material layer formed on the collector is formed of the inorganic solid electrolyte-containing composition according to the embodiment of the present invention, it is also possible to strengthen the adhesiveness between the collector and the active material layer, and thus it is possible to achieve a further improvement of the cycle characteristics.

Although the details of the reason for the above are not yet clear, they are conceived to be as follows.

In the inorganic solid electrolyte-containing composition, a polymer binder (hereinafter, may be simply referred to as a binder) that is soluble in a dispersion medium is used (a binder that is soluble in a dispersion medium may be referred to as a soluble binder). Therefore, in this composition, the dispersibility of the solid particles such as the inorganic solid electrolyte is enhanced by the binder, and the solid particles are less likely to be unevenly distributed in the composition, whereby it is possible to form a constitutional layer in which the solid particles are uniformly disposed. It is conceived that this constitutional layer is less likely to generate an overcurrent even by the charging and discharging of an all-solid state secondary battery and thus the deterioration of the solid particles can be suppressed. In this way, the ion conductivity and the cycle characteristics can be improved.

Furthermore, in the present invention, the surface energy of the polymer contained in the binder is set to 20 mN/m or less, and the SP value is set to 14 to 21.5 MPa^{1/2}.

In a case of setting the SP value of the polymer in the above range, it is possible to further enhance the affinity of a binder to a dispersion medium, and it is possible for a binder in a state of being dissolved to be highly dispersed. As a result, it is possible to uniformly dispose the solid particles in the constitutional layer, and it is possible to further enhance the improvement of the battery characteristics based on the solubility.

In addition, a soluble binder generally tends to excessively coat the surface of solid particles such as an inorganic solid electrolyte and increases the interface resistance (contact resistance) of the inorganic solid electrolyte (decreases the ion conductivity). However, in a case where the surface energy of the polymer contained in the soluble binder is set in the above range, it is conceived that the binder is repelled on the surface of the inorganic solid electrolyte to be scattered and precipitated even in a case where the binder is adsorbed on the surface of the inorganic solid electrolyte, and thus it is possible to maintain the direct contact between the inorganic solid electrolytes (the contact without the intervention of the binder) without significantly impairing the firm adhesion between the inorganic solid electrolytes. Therefore, it is possible to reduce the interface resistance of the inorganic solid electrolyte, and it is possible to suppress the inhibition of the ion conduction between the inorganic solid electrolytes even in a low temperature environment.

Moreover, since a binder having a small surface energy is adsorbed on the surface of the inorganic solid electrolyte, it is possible to effectively inhibit the contact of water with the inorganic solid electrolyte. In this way, in the inorganic solid electrolyte-containing composition and the constitutional layer, it is possible to suppress the increase in the resistance of the inorganic solid electrolyte in a low temperature environment and the increase in the resistance due to deterioration.

In the inorganic solid electrolyte-containing composition according to the embodiment of the present invention, it is conceived that the above-described effects are exhibited by using the above-described soluble binder in combination with an inorganic solid electrolyte and a dispersion medium, and thus it is possible to realize an all-solid state secondary battery having low resistance and excellent cycle characteristics even in a low temperature environment.

In a case where an active material layer is formed of the inorganic solid electrolyte-containing composition according to the embodiment of the present invention, a constitutional layer is formed while a high dispersed state is maintained as described above. Therefore, it is conceived that the binder can be brought into contact with (closely attached to) the surface of the collector in a state where the binder and the solid particles are dispersed. This makes it possible to realize the firm adhesiveness between the collector and the active material and makes it possible to further improve the cycle characteristics and the conductivity.

The inorganic solid electrolyte-containing composition according to the embodiment of the present invention is preferably used as a material (a constitutional layer forming material) for forming a solid electrolyte layer or an active material layer, where the material is for a sheet for an all-solid state secondary battery (including an electrode sheet for an all-solid state secondary battery) or an all-solid state secondary battery. In particular, it can be preferably used as a material for forming a negative electrode sheet for an all-solid state secondary battery or a material for forming a negative electrode active material layer, which contains a negative electrode active material having a large expansion and contraction due to charging and discharging, and high cycle characteristics and furthermore, high conductivity can be achieved in this aspect as well.

The inorganic solid electrolyte-containing composition according to the embodiment of the present invention is preferably a non-aqueous composition. In the present invention, the non-aqueous composition includes not only an aspect including no water but also an aspect where the moisture content (also referred to as the “water content”) is preferably 500 ppm or less. In the non-aqueous composition, the moisture content is more preferably 200 ppm or less, still more preferably 100 ppm or less, and particularly preferably 50 ppm or less. In a case where the inorganic solid electrolyte-containing composition is a non-aqueous composition, it is possible to suppress the deterioration of the inorganic solid electrolyte. The water content refers to the water amount (the mass proportion to the inorganic solid electrolyte-containing composition) in the inorganic solid electrolyte-containing composition, and specifically, it is a value measured by carrying out filtration through a 0.02 μm membrane filter and then Karl Fischer titration.

The inorganic solid electrolyte-containing composition according to the aspect of the present invention includes an aspect containing not only an inorganic solid electrolyte but also an active material, as well as a conductive auxiliary agent or the like (the composition in this aspect may be referred to as the “electrode composition”).

Hereinafter, components that are contained and components that can be contained in the inorganic solid electrolyte-containing composition according to the embodiment of the present invention will be described.

<Inorganic Solid Electrolyte>

The inorganic solid electrolyte-containing composition contains an inorganic solid electrolyte (it is also referred to as inorganic solid electrolyte particles in a case of having a particle shape).

In the present invention, the inorganic solid electrolyte is an inorganic solid electrolyte, where the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity. In a case where the all-solid state secondary battery according to the embodiment of the present invention is a lithium ion battery, the inorganic solid electrolyte preferably has a lithium ion conductivity.

As the inorganic solid electrolyte, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

(i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which contain, as elements, at least Li, S, and P and have a lithium ion conductivity, but the sulfide-based inorganic solid electrolytes may also include elements other than Li, S, and P depending on the purposes or cases.

Among the inorganic solid electrolytes, the sulfide-based inorganic solid electrolyte has a particularly high reactivity with water, and thus it is important to avoid contact with water (moisture) not only at the time of preparing the composition but also even in a case where the sulfide-based inorganic solid electrolyte has formed a constitutional layer. However, in the present invention, since it is used in combination with the above-described soluble binder, the deterioration of the sulfide-based inorganic solid electrolyte can be effectively prevented.

Examples of the sulfide-based inorganic solid electrolyte include a lithium ion-conductive inorganic solid electrolyte satisfying the composition represented by Formula (S1).

Lₐ₁M_{b1}P_{c1}S_{d1}Aₑ₁ (S1)

In the formula, L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase a lithium ion conductivity. Specifically, the lithium ion conductivity can be preferably set to 1×10⁻⁴ S/cm or more and more preferably set to 1×10⁻³ S/cm or more. The upper limit thereof is not particularly limited, however, it is practically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S-Ge_{S}2-Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S-Si_{S}2-P₂S₅—LiI, Li₂S—SiS₂—LiI, Li₂S—SiS₂—Li₄SiO₄, Li₂S—SiS₂—Li₃PO₄, and Li₁₀GeP₂Si₂. The mixing ratio between the individual raw materials does not matter. Examples of the method of synthesizing a sulfide-based inorganic solid electrolyte material using the above-described raw material compositions include an amorphization method. Examples of the amorphization method include a mechanical milling method, a solution method, and a melting quenching method. This is because treatments at a normal temperature become possible, and it is possible to simplify manufacturing processes.

(ii) Oxide-Based Inorganic Solid Electrolytes

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit thereof is not particularly limited; however, it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn, xc satisfies 0<xc≤5, yc satisfies 0<yc≤1, zc satisfies 0<zc≤1, and nc satisfies 0<nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13.); Li₍₃₋₂ₓₑ₎M^{ee}ₓₑD^{ee}O (xe represents a number 0 or more and 0.1 or less and M^{ee} represents a divalent metal atom, D^{ee} represents a halogen atom or a combination of two or more halogen atoms); Li_{xf}Si_{yf}O_{zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen in lithium phosphate is substituted with nitrogen; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

(iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte is preferably particulate. In this case, the particle diameter (the volume average particle diameter) of the inorganic solid electrolyte is not particularly limited; however, it is preferably 0.01 μm or more and more preferably 0.1 μm or more. The upper limit thereof is preferably 100 μm or less and more preferably 50 μm or less.

The particle diameter of the inorganic solid electrolyte is measured according to the following procedure. Using water (heptane in a case where the inorganic solid electrolyte is unstable in water), the inorganic solid electrolyte particles are diluted in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/scattering-type particle size distribution analyzer LA-920 (product name, manufactured by Horiba Ltd.), and a quartz cell for measurement at a temperature of 25° C. to obtain the volume average particle diameter. Other detailed conditions and the like can be found in JIS Z8828: 2013 “particle diameter Analysis-Dynamic Light Scattering” as necessary. Five samples per level are produced, and the average values therefrom are employed.

The inorganic solid electrolyte-containing composition may contain one kind or two or more kinds of inorganic solid electrolytes.

The content of the inorganic solid electrolyte in the inorganic solid electrolyte-containing composition is not particularly limited. However, from the viewpoints of dispersibility and ion conductivity, it is preferably 50% by mass or more, more preferably 70% by mass or more, and still more preferably 90% by mass or more, with respect to 100% by mass of the solid content. From the same viewpoint, the upper limit thereof is preferably 99.9% by mass or less, more preferably 99.5% by mass or less, and particularly preferably 99% by mass or less.

However, in a case where the inorganic solid electrolyte-containing composition contains an active material described later, regarding the content of the inorganic solid electrolyte in the inorganic solid electrolyte-containing composition, the total content of the active material and the inorganic solid electrolyte is preferably in the above-described range.

In the present invention, the solid content (solid component) refers to components that neither volatilize nor evaporate and disappear in a case where the inorganic solid electrolyte-containing composition is subjected to drying treatment at 150° C. for 6 hours in a nitrogen atmosphere at a pressure of 1 mmHg. Typically, the solid content refers to a constitutional component other than a dispersion medium described later.

<Polymer Binder>

The inorganic solid electrolyte-containing composition according to the embodiment of the present invention contains one kind of polymer binder or two or more kinds thereof. The polymer binder that is used in the present invention is formed by containing a binder by using a polymer having a surface energy of 20 mN/m or less and an SP value of 14 to 21.5 MPa^{1/2} and dissolved in a dispersion medium contained in the inorganic solid electrolyte-containing composition. In a case of using this polymer binder in combination with an inorganic solid electrolyte and a dispersion medium, it is possible to prepare an inorganic solid electrolyte-containing composition which is excellent in dispersibility and hardly deteriorates an inorganic solid electrolyte, and further, it is possible to produce a constitutional layer which exhibits a high ion conductivity and hardly deteriorates even in a low temperature environment.

The polymer contained in the polymer binder may contain another polymer as long as the polymer binder contains a polymer that satisfies the above-described surface energy and SP value, as long as the action of these components is not impaired.

(Physical Properties, Characteristics, or the Like of Polymer Binder or Binder Forming Polymer)

Regarding the achievement of the object of the present invention, the surface energy and the SP value, which are the characteristical characteristic of a polymer that forms a polymer binder (also referred to as a binder forming polymer), will be described.

This binder forming polymer has a surface energy of 20 mN/m or less. Due to having the surface energy in this range, the binder containing the binder forming polymer can prevent the deterioration of the inorganic solid electrolyte while reducing the interface resistance of the solid particles such as the inorganic solid electrolyte as described above.

The surface energy of the binder forming polymer is preferably 18 mN/m or less, more preferably 16 mN/m or less, and still more preferably 14 mN/m or less. The lower limit value of the surface energy is not particularly limited; however, it is practically 3 mN/m or more, preferably 5 mN/m or more, more preferably 8 mN/m or more, and still more preferably 9 mN/m or more. The surface energy of the binder forming polymer shall be a value calculated according to the method described in Examples.

The binder forming polymer has an SP value of 14 to 21.5 MPa^{1/2}. Due to having the SP value in this range, the dispersibility of the binder dissolved in the dispersion medium can be further improved as described above. The SP value of the binder forming polymer is preferably less than 21.5 MPa^{1/2}, more preferably 20 MPa^{1/2} or less, and still more preferably 19 MPa^{1/2} or less. The lower limit value of the SP value is preferably 15 MPa^{1/2} or more, more preferably 16 MPa^{1/2} or more, and still more preferably 17 MPa^{1/2} or more.

The method of calculating the SP value will be described.

First, the SP value (MPa^{1/2}) of each constitutional component constituting the binder forming polymer is determined according to the Hoy method unless otherwise specified (see the following formula in H. L. Hoy JOURNAL OF PAINT TECHNOLOGY, Vol. 42, No. 541, 1970, 76-118, and POLYMER HANDBOOK 4^{th}, Chapter 59, VII, page 686, Table 5, Table 6, and the following formula in Table 6).

As necessary, the SP value obtained according to the above document is converted into an SP value (MPa^{1/2}) (for example, 1 cal^{1/2} cm^{-3/2}≈2.05 J^{1/2} cm^{-3/2}≈2.05 MPa^{1/2}).

$${δ}_{t} = \frac{{F}_{t} + \frac{B}{\overline{n}}}{V} ; B = 277$$

In the expression, δₜ indicates an SP value. Ft is a molar attraction function (J×cm³)^{1/2}/mol and represented by the following expression. V is a molar volume (cm³/mol) and represented by the following expression. n̅ is represented by the following expression.

$${F}_{t} = \sum {n}_{i} {F}_{t , i} V = \sum {n}_{i} {V}_{i} \overline{n} = \frac{0.5}{{Δ}_{T}^{( P )}} {Δ}_{T}^{( P )} = \sum {n}_{i} {Δ}_{T , i}^{( P )}$$

In the above formula, F_{t,i} indicates a molar attraction function of each constitutional unit, Vᵢ indicates a molar volume of each constitutional unit, Δ^{(p)}_{T,i} indicates a correction value of each constitutional unit, and nᵢ indicates the number of each constitutional unit.

Using the obtained SP value of the constitutional component determined as described above (MPa^{1/2}), the SP value (MPa^{1/2}) of the binder forming polymer is calculated from the following expression.

SP²=(SP₁²×W₁)+(SP₂²×W₂)+ . . .

In the expression, SP₁, SP₂ . . . indicates the SP values of the constitutional components, and W₁, W₂ . . . indicates the mass fractions of the constitutional components. The mass fraction of a constitutional component shall be a mass fraction of the constitutional component (the raw material compound from which this constitutional component is derived) in the binder forming polymer.

The SP value of the binder forming polymer can be adjusted depending on the kind or the composition (the kind and the content of the constitutional component) of the binder forming polymer.

It is preferable that the SP value of the binder forming polymer satisfies a difference (in terms of absolute value) in SP value in a range described later with respect to the SP value of the dispersion medium from the viewpoint of achieving a higher dispersibility.

The polymer binder or the binder forming polymer, which is used in the present invention, preferably has the following physical properties or characteristics.

The binder forming polymer preferably has a (tensile) elastic modulus of 1 MPa or more. In a case of having an elastic modulus in this range, it is possible to further strengthen the adhesion of the solid particles, and it is also possible to expect the improvement of the film forming property of the inorganic solid electrolyte-containing composition. This results in the contribution to further improvement of the cycle characteristics of the all-solid state secondary battery.

The elastic modulus of the binder forming polymer is preferably 5 MPa or more, more preferably 10 MPa or more, and still more preferably 15 MPa or more. The upper limit value of the elastic modulus is not particularly limited; however, it is practically 800 MPa or less, preferably 600 MPa or less, more preferably 400 MPa or less, and still more preferably 100 MPa or less. The elastic modulus of the binder forming polymer is a value calculated according to the method described in Examples.

In the present invention, the elastic modulus can be appropriately set depending on the kind, composition, and the like of the binder forming polymer.

The moisture concentration of the polymer binder (the polymer) is preferably 100 ppm (mass basis) or less. Further, for this polymer binder, a polymer may be crystallized and dried, or a polymer binder dispersion liquid may be used as it is.

The polymer that forms a polymer binder is preferably amorphous. In the present invention, the description that a polymer is “amorphous” typically refers to that no endothermic peak due to crystal melting is observed when the measurement is carried out at the glass transition temperature.

The polymer that forms a polymer binder may be a non-crosslinked polymer or a crosslinked polymer. In addition, in a case where the crosslinking of the polymer progresses due to heating or voltage application, the molecular weight may be higher than the above-described molecular weight. Preferably, the polymer has a mass average molecular weight in the range described later at the start of use of the all-solid state secondary battery.

The mass average molecular weight of the polymer that forms the polymer binder is not particularly limited. It is, for example, preferably 15,000 or more, more preferably 30,000 or more, and still more preferably 50,000 or more. The upper limit thereof is practically 5,000,000 or less, preferably 4,000,000 or less, more preferably 3,000,000 or less, and still more preferably 100,000 or less.

—Measurement of Molecular Weight—

In the present invention, unless specified otherwise, molecular weights of a polymer chain and a macromonomer refer to a mass average molecular weight and number average molecular weight in terms of standard polystyrene conversion, which are determined according to gel permeation chromatography (GPC). Regarding the measurement method thereof, basically, a value measured according to a method under the condition 1 or the condition 2 (preferential) described below is employed. However, depending on the kind of polymer or macromonomer, an appropriate eluent may be appropriately selected and used.

(Conditions 1)

Column: Connect two TOSOH TSKgel Super AWM-H (product name, manufactured by Tosoh Corporation)

Carrier: 10 mM LiBr/N-methylpyrrolidone

Measurement temperature: 40° C.

Carrier flow rate: 1.0 ml/min

Sample concentration: 0.1% by mass

Detector: refractive indicator (RI) detector

(Conditions 2)

Column: A column obtained by connecting TOSOH TSKgel Super HZM-H, TOSOH TSKgel Super HZ4000, and TOSOH TSKgel Super HZ2000 (all of which are product names, manufactured by Tosoh Corporation)

Carrier: tetrahydrofuran

Measurement temperature: 40° C.

Carrier flow rate: 1.0 ml/min

Sample concentration: 0.1% by mass

Detector: refractive indicator (RI) detector

(Binder Forming Polymer)

Regarding the binder forming polymer, the kind of polymer, the composition of the binder forming polymer, and the like are not particularly limited as long as the solubility in a dispersion medium, the above-described surface energy, and the above-described SP value are satisfied. Examples thereof include sequential polymerization (polycondensation, polyaddition, or addition condensation) polymers such as polyurethane, polyurea, polyamide, polyimide, polyester, a polycarbonate resin, and a polyester resin; chain polymerization polymers such as a fluorine-containing polymer, a hydrocarbon polymer, a vinyl polymer, and (meth)acrylic polymer, and copolymerization polymers thereof. Among them, a chain polymerization polymer is preferable, and a vinyl polymer or a (meth)acrylic polymer is more preferable.

The polymerization mode of the binder forming polymer is not particularly limited, and the binder forming polymer may be any one of a block polymer, an alternating copolymerization polymer, a random polymer, and a graft polymer. The graft polymer means a polymer having a graft chain as a side chain regardless of the polymerization mode of the main chain, and specifically refers to a polymer having a repeating unit in a molecular chain constituting the side chain.

In terms of the improvement of dispersibility and ion conductivity, the suppression of the deterioration of the inorganic solid electrolyte, and the adhesiveness, which are obtained by the above-described effects being effectively exhibited, the binder forming polymer is preferably a block polymer in which the main chain is a block copolymer (regardless of the polymerization mode of the side chain), or a graft polymer (regardless of the polymerization mode of the main chain).

In the present invention, a main chain of the polymer refers to a linear molecular chain in which all the molecular chains that constitute the polymer other than the main chain can be conceived as a branched chain or a pendant with respect to the main chain. Although it depends on the mass average molecular weight of the molecular chain regarded as a branched chain or pendant chain, the longest chain among the molecular chains constituting the polymer is typically the main chain. In this case, a terminal group at the polymer terminal is not included in the main chain. In addition, side chains of the polymer refer to molecular chains other than the main chain and include a short molecular chain and a long molecular chain (a graft chain).

The constitutional components and the content of the binder forming polymer are determined in a range in which the solubility in a dispersion medium, the surface energy, and the SP value are satisfied, the details of which will be described later.

Examples of the (meth)acrylic polymer suitable as the binder forming polymer include a polymer obtained by (co)polymerizing a (meth)acrylic compound (M1), the polymer containing 50% by mass or more of a constitutional component derived from the (meth)acrylic compound (M1).

Examples of the vinyl polymer suitable as the binder forming polymer include a polymer obtained by (co)polymerizing a vinyl monomer other than the (meth)acrylic compound (M1), the polymer containing 50% by mass or more of a constitutional component derived from the vinyl monomer.

In addition to both the constitutional components of the constitutional component derived from the (meth)acrylic compound (M1) and the constitutional component derived form from the vinyl monomer, the binder forming polymer preferably has a constitutional component derived from an ethylenically unsaturated monomer (a polymerizable compound) having a fluorine atom or a silicon atom and further a constitutional component derived from a macromonomer.

Examples of the ethylenically unsaturated monomer having a fluorine atom or a silicon atom include a compound having an ethylenically unsaturated group (a polymerizable group), and a fluorine atom or a group containing a fluorine atom or a silicon atom. The group containing a fluorine atom or a silicon atom is not particularly limited; however, examples thereof include R^{F} in Formula (LF) and R^{S} in Formula (LS), which will be described later. The ethylenically unsaturated group may be directly bonded or may be bonded to the group containing a fluorine atom or a silicon atom through a linking group. The linking group that bonds the ethylenically unsaturated group to the group containing a fluorine atom or a silicon atom is not particularly limited, and examples thereof include L in Formula (LF) described later. Examples of such an ethylenically unsaturated monomer include fluorine-substituted ethylene such as tetrafluoroethylene (TFE) and vinylidene difluoride (VdF), and a compound from which a constitutional component represented by Formula (LF) or formula (LS) is derived.

Examples of the compound from which a constitutional component represented by Formula (LF) or formula (LS) is derived include, in addition to compounds from which constitutional components of the exemplary polymer and the polymers in Examples described later are derived, hexafluoropropylene (HFP) as the compound from which a constitutional component represented by Formula (LF) is derived.

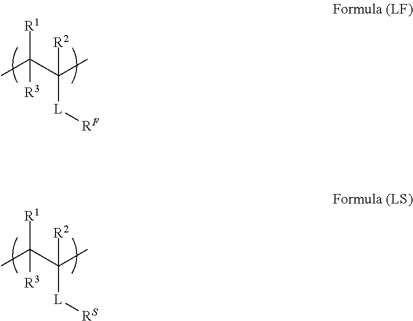

In Formula (LF) or Formula (LS), R¹ to R³ represent a hydrogen atom or a substituent,

The substituent that can be adopted as R¹ to R³ is not particularly limited and is selected from the substituent Z described later, where an alkyl group or a halogen atom is preferable. R¹ and R³ are each preferably a hydrogen atom, and R² is preferably a hydrogen atom or methyl.

L represents a single bond or a linking group, where a linking group is preferable.

The linking group that can be adopted as L is not particularly limited; however, examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—: R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P(OH)(O)—O—), and a group involved in the combination thereof. The linking group is preferably a group obtained by combining an alkylene group, an arylene group, a carbonyl group, an oxygen atom, a sulfur atom, and an imino group, more preferably a group obtained by combining an alkylene group, an arylene group, a carbonyl group, an oxygen atom, and an imino group, still more preferably a group containing a —CO—O— group, a —CO—N(R^{N})— group (R^{N} represents a hydrogen atom, an alkyl group having 1 to 6 carbon atoms, or an aryl group having 6 to 10 carbon atoms), and particularly preferably a —CO—O— group or —CO—N(R^{N})— group (R^{N} is as described above). The number of atoms that constitute the linking group and the number of linking atoms are as described below. However, the above does not apply to the polyalkyleneoxy chain that constitutes the linking group.

In the present invention, the number of atoms that constitute the linking group is preferably 1 to 36, more preferably 1 to 24, still more preferably 1 to 12, and particularly preferably 1 to 6. The number of linking atoms of the linking group is preferably 10 or less and more preferably 8 or less. The lower limit thereof is 1 or more. The number of linking atoms refers to the minimum number of atoms linking predetermined structural parts. For example, in a case of —CH₂—C(═O)—O—, the number of atoms that constitute the linking group is 6; however, the number of linking atoms is 3.

Each of the hydrocarbon group (the alkyl group or the like) and the linking group may have or may not have a substituent. Examples of the substituent which may be contained include the substituent Z, and suitable examples thereof include a halogen atom.

R^{F} represents a substituent containing a carbon atom and a fluorine atom. The substituent containing both atoms is not particularly limited. However, examples thereof include a fluorine-substituted hydrocarbon group, and specific examples thereof include a fluoroalkyl group and a fluoroaryl group. Among them, a fluoroalkyl group is preferable, and a primary fluoroalkyl group is more preferable in terms of the reduction of the interface resistance and the prevention of the deterioration.

The fluoroalkyl group is a group obtained by substituting at least one hydrogen atom of an alkyl group or a cycloalkyl group with a fluorine atom, where the fluoroalkyl group preferably has 1 to 20 carbon atoms, and in terms of the reduction of the interface resistance and the prevention of the deterioration, it more preferably has 2 to 15 carbon atoms, still more preferably 3 to 10 carbon atoms, and particularly preferably 4 to 8 carbon atoms. Regarding the number of fluorine atoms on the carbon atom, a part of the hydrogen atoms may be substituted, or all the hydrogen atoms may be substituted (a perfluoroalkyl group). Among the above, it is preferable that the carbon atom bonded to L in the formula is not substituted with fluorine, and it is more preferable that the carbon atom on the terminal side of the alkyl group is substituted with fluorine. For example, a fluoroalkyl group represented by the formula: CₙF₍₂ₙ₊₁₎CₘH₍₂ₘ₎— is suitably included. In the formula, m is 1 or 2, and the total of n and m is the same as the number of carbon atoms of the alkyl group.

The fluoroaryl group is a group obtained by substituting at least one hydrogen atom of an aromatic hydrocarbon with a fluorine atom, where the fluoroaryl group preferably has 6 to 24 carbon atoms and more preferably 6 to 10 carbon atoms. Regarding the number of fluorine atoms on the carbon atom, a part of the hydrogen atoms may be substituted, or all the hydrogen atoms may be substituted (a perfluoroaryl group).

Specific examples of the fluoroalkyl group and the fluoroaryl group include each group contained in the exemplary polymer and the polymers synthesized in Examples described later, which are not limited to in the present invention.

R^{S} represents a substituent containing a silicon atom. Suitable examples of the substituent containing a silicon atom include a siloxane group, and for example, a group having a structure represented by —(SiR₂—O)ₙ— is preferable. R represents a hydrogen atom or a substituent, where a substituent is preferable. The substituent is not particularly limited. Examples thereof include those selected from the substituent Z described later, where an alkyl group or an aryl group is preferable. The (average) repetition number n is preferably 1 to 100, more preferably 10 to 80, and still more preferably 20 to 50. The group to be bonded to the terminal of the structure represented by —(SiR₂—O)ₙ— is not particularly limited, and an alkyl group or an aryl group that can be adopted as R is preferable.

Here, in a case where the repetition number n is 2 or more, the binder forming polymer having a constitutional component represented by Formula (LS) serves as a graft polymer, and the side chain thereof has R^{S} of the constitutional component represented by Formula (LS).

Examples of the (meth)acrylic compound (M1) include a (meth)acrylic acid compound, a (meth)acrylic acid ester compound, a (meth)acrylamide compound, and a (meth)acrylonitrile compound, where a (meth)acrylic acid ester compound or a (meth)acrylonitrile compound is preferable.

Examples of the (meth)acrylic acid ester compound include a (meth)acrylic acid alkyl ester compound and a (meth)acrylic acid aryl ester compound, where a (meth)acrylic acid alkyl ester compound is preferable. The number of carbon atoms of the alkyl group constituting the (meth)acrylic acid alkyl ester compound is not particularly limited; however, it can be set to, for example, 1 to 24, and it is preferably 3 to 20, more preferably 4 to 16, and still more preferably 6 to 14, in terms of the dispersibility and the improvement of the battery characteristics. The number of carbon atoms of the aryl group constituting the aryl ester is not particularly limited; however, it can be set to, for example, 6 to 24, and it is preferably 6 to 10. In the (meth)acrylamide compound, the nitrogen atom of the amide group may be substituted with an alkyl group or an aryl group.

The vinyl monomer is not particularly limited; however, it is preferably a vinyl compound (M2) that is copolymerizable with the (meth)acrylic compound (M1), where examples thereof include aromatic vinyl compounds such as a styrene compound, a vinyl naphthalene compound, and a vinyl carbazole compound and further include an allyl compound, a vinyl ether compound, a vinyl ester compound, a dialkyl itaconate compound, and an unsaturated carboxylic acid anhydride. Examples of the vinyl compound include the “vinyl monomer” disclosed in JP2015-88486A. Among them, an aromatic vinyl compound is preferable, and a styrene compound is more preferable. Specific examples of the preferred vinyl compound (M2) include styrene, methyl styrene, chlorostyrene, trifluoromethyl styrene, and pentafluorostyrene.

The (meth)acrylic compound (M1) and the vinyl compound (M2) may have a substituent. The substituent is not particularly limited, and examples thereof include a group selected from the substituent Z described later, where a form in which the substituent is not substituted with a fluorine atom is preferable.

The (meth)acrylic compound (M1) and the vinyl compound (M2), from which the constitutional component of the (meth)acrylic polymer is derived, are preferably a compound represented by Formula (b-1).

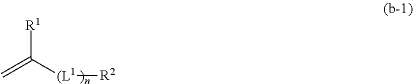

In the formula, R¹ represents a hydrogen atom, a hydroxy group, a cyano group, a halogen atom, an alkyl group (preferably having 1 to 24 carbon atoms, more preferably 1 to 12 carbon atoms, and particularly preferably 1 to 6 carbon atoms), an alkenyl group (preferably having 2 to 24 carbon atoms, more preferably 2 to 12 carbon atoms, and particularly preferably 2 to 6 carbon atoms), an alkynyl group (preferably having 2 to 24 carbon atoms, more preferably 2 to 12 carbon atoms, and particularly preferably 2 to 6 carbon atoms), or an aryl group (preferably having 6 to 22 carbon atoms and more preferably 6 to 14 carbon atoms). Among the above, a hydrogen atom or an alkyl group is preferable, and a hydrogen atom or a methyl group is more preferable.

R² represents a hydrogen atom or a substituent. The substituent that can be adopted as R² is not particularly limited. However, examples thereof include an alkyl group (preferably a linear chain although it may be a branched chain), an alkenyl group (preferably having 2 to 12 carbon atoms, more preferably 2 to 6 carbon atoms, and particularly preferably 2 or 3 carbon atoms), an aryl group (preferably having 6 to 22 carbon atoms and more preferably 6 to 14 carbon atoms), an aralkyl group (preferably having 7 to 23 carbon atoms and more preferably 7 to 15 carbon atoms), and a cyano group.

The number of carbon atoms of the alkyl group has the same meaning as the number of carbon atoms of the alkyl group constituting the (meth)acrylic acid alkyl ester compound, and the same applies to the preferred range thereof.

L¹ is a linking group and is not particularly limited, and examples thereof include L of Formula (LF).

In a case where L¹ adopts a —CO—O— group or a —CO—N(R^{N})— group (R^{N} is as described above), the compound represented by Formula (b-1) corresponds to the (meth)acrylic compound (M1), the others correspond to the vinyl compound (M2).

n is 0 or 1 and preferably 1. However, in a case where -(L¹)ₙ-R² represents one kind of substituent (for example, an alkyl group), n is set to 0, and R² is set to a substituent (an alkyl group).

In Formula (b-1), the carbon atom which forms a polymerizable group and to which R¹ is not bonded is represented as an unsubstituted carbon atom (H₂C═); however, it may have a substituent. The substituent is not particularly limited; however, examples thereof include the above group that can be adopted as R¹.

Further, in Formula (b-1), the group which may adopt a substituent such as an alkyl group, an aryl group, an alkylene group, or an arylene group may have a substituent within a range where the effect of the present invention is not impaired. The substituent is not particularly limited, and examples thereof include a group selected from the substituent Z described later, where a form in which the substituent is not substituted with a fluorine atom is preferable.

Examples of the macromonomer from which, a constitutional component derived from a macromonomer which may be contained in the binder forming polymer, is derived include those having a number average molecular weight of 1,000 or more (according to the measuring method for the above-described mass average molecular weight), where is 3,000 or more is more preferable. The upper limit thereof is not particularly limited; however, it can be set to, for example, 500,000, and it is preferably 30,000 or less.

The macromonomer preferably has the above-described ethylenically unsaturated group and a polymerized chain. As the polymerized chain, a chain consisting of a general polymer can be applied without particular limitations. However, in the present invention, it is preferably a polymerized chain consisting of a (meth)acrylic polymer or a polymerized chain consisting of polysiloxane. The polymerized chain consisting of the (meth)acrylic polymer preferably has a constitutional component derived from the (meth)acrylic compound (M1), a constitutional component derived from the vinyl compound (M2), and furthermore, the constitutional component derived from the above-described ethylenically unsaturated monomer having a fluorine atom or a silicon atom, in particular, the constitutional component represented by Formula (LF) or Formula (LS). Among them, a polymerized chain having a (meth)acrylic acid ester compound and a constitutional component represented by Formula (LF) is more preferable. The polymerized chain consisting of polysiloxane is preferably a polymerized chain consisting of the group having a structure represented by —(SiR₂—O)ₙ—, which can be adopted as R^{S}. The content of each constitutional component in the polymerized chain of the macromonomer is not particularly limited and is appropriately set. For example, the content of the constitutional component derived from the (meth)acrylic compound (M1) in the polymerized chain of the macromonomer is, for example, preferably 40% to 90% by mass, more preferably 50% to 80% by mass, and more preferably 60% to 70% by mass. Similarly, the content of the constitutional component represented by Formula (LF) or Formula (LS) is, for example, preferably 10% to 60% by mass, more preferably 20% to 50% by mass, and still more preferably 30% to 40% by mass.

The linking group that links the ethylenically unsaturated group to the polymerized chain is not particularly limited, and it is preferably each of various bonds such as a single bond, an ester bond (a —CO—O— group), an amide bond (a —CO—N(R^{N})— group (R^{N} is as described above)), a urethane bond (a —N(R^{N})—CO— group (R^{N} is as described above), a urea bond (a —N(R^{N})—CO—N(R^{N})— group (R^{N} is as described above)), an ether bond, and a carbonate bond (a —O—CO— group), a di-substituted benzene (a phenylene group), a linking group having a structural part derived from a chain transfer agent, a polymerization initiator, or the like, which is used in the synthesis, or a linking group in which these are combined, and examples thereof include a linking group that can be adopted as the above-described L. However, a group including a —CO—O— group or a —CO—N(R^{N})— group (R^{N} is as described above) and including a structural part derived from a chain transfer agent, a polymerization initiator, or the like is preferable. Examples of the linking group include a linking group of the constitutional component derived from a macromonomer contained in each of the polymers synthesized in Examples.

In the present invention, examples of the macromonomer include macromonomers from which constitutional components contained in the following exemplary polymer and the polymers synthesized in Examples are derived, and furthermore, the macromonomer described in JP2015-088486A.

The binder forming polymer having a constitutional component derived from this macromonomer serves as a graft polymer.

The binder forming polymer preferably has the constitutional component represented by Formula (LF) or Formula (LS) in the main chain or the side chain (the graft chain).

In a case where the constitutional component represented by Formula (LF) is contained in the side chain, it is preferable that this constitutional component is incorporated into the polymerized chain of the macromonomer described above.

In a case where R^{S} of the constitutional components represented by Formula (LS) is a group having a structure represented by —(SiR₂—O)ₙ— (n is 2 or more), this constitutional component corresponds to a constitutional component derived from a macromonomer, and a binder forming polymer having this constitutional component in the main chain serves as a graft polymer.

It is preferable that the binder forming polymer has a constitutional component derived from the (meth)acrylic compound (M1), particularly a constitutional component derived from the (meth)acrylic acid ester compound, from the viewpoint that it can be closely attached to the inorganic solid electrolyte and the active material, thereby improving the dispersibility, the adhesiveness between solid particles, and the adhesiveness to the collector.

In addition, it is preferable that the binder forming polymer has a constitutional component derived from the (meth)acrylonitrile compound among the (meth)acrylic compounds (M1), from the viewpoint that it is possible to further increase the elastic modulus of the binder forming polymer, in addition to the adhesiveness to the inorganic solid electrolyte and the active material.

Further, it is preferable that the binder forming polymer has a constitutional component derived from a styrene compound among the vinyl compounds from the viewpoint that the elastic modulus of the binder forming polymer can be increased.

The content of each constitutional component in the binder forming polymer is not particularly limited and is appropriately determined in consideration of the surface energy and the SP value.

The content of each constitutional component in the vinyl polymer is set, for example, in the following range such that the total content of all the constitutional components is 100% by mass.

For example, in the vinyl polymer, the content of the constitutional component derived from the vinyl compound (including the constitutional component represented by Formula (LF) or Formula (LS)) can be set to 100% by mass; however, it is preferably 50% to 90% by mass, more preferably 60% to 80% by mass, and particularly preferably 65% to 75% by mass. The content of the constitutional component derived from the styrene compound among the vinyl compounds is set in a range that satisfies the above range, and it is preferably 55% to 80% by mass and more preferably 60% to 70% by mass.

In the vinyl polymer, the content of the constitutional component derived from the (meth)acrylic compound (M1) is set to be less than 50% by mass, and it is preferably 0% to 40% by mass and more preferably 5% to 35% by mass. Among the (meth)acrylic compounds (M1), the content of the constitutional component derived from the (meth)acrylic acid ester compound (excluding the constitutional component represented by Formula (LF) or Formula (LS)) is set within the above range; however, it is preferably 0% to 40% by mass and more preferably 5% to 35% by mass. In addition, among the (meth)acrylic compounds (M1), the content of the constitutional component derived from the (meth)acrylonitrile compound is set within the above range, it is preferably 0% to 40% by mass and more preferably 5% to 35% by mass.

The content of the constitutional component derived from an ethylenically unsaturated monomer having a fluorine atom or a silicon atom is, for example, preferably 3% to 60% by mass, more preferably 5% to 60% by mass, still more preferably 10% to 50% by mass, and particularly preferably 15% to 40% by mass. Among the above, the content of the constitutional component represented by Formula (LF) or Formula (LS) and incorporated in the main chain of the vinyl polymer is set within the above-described range; however, for example, preferably 5% to 60% by mass, more preferably 10% to 55% by mass, and more preferably 15% to 50% by mass.

The content of the constitutional component derived from the macromonomer is, for example, preferably 5% to 50% by mass, more preferably 10% to 40% by mass, and still more preferably 15% to 35% by mass. However, in a case where the constitutional component derived from the macromonomer includes, in the polymerized chain thereof, a constitutional component derived from an ethylenically unsaturated monomer having a fluorine atom or a silicon atom, the content of the constitutional component derived from the macromonomer is included in “the content of the constitutional component derived from the ethylenically unsaturated monomer having a fluorine atom or a silicon atom” described above.

The content of each constitutional component in the (meth)acrylic polymer is set, for example, in the following range such that the total content of all the constitutional components is 100% by mass.

For example, the content of the constitutional component (including the constitutional component represented by Formula (LF) or Formula (LS)) derived from the (meth)acrylic compound (M1) can be set to 100% by mass; however, is, for example, preferably 50% to 90% by mass and more preferably 55% to 80% by mass. Among the (meth)acrylic compounds (M1), the content of the constitutional component derived from the (meth)acrylic acid ester compound (excluding the constitutional component represented by Formula (LF) or Formula (LS)) is set in a range that satisfies the above range, and it is preferably 35% to 90% by mass, more preferably 50% to 85% by mass, still more preferably 55% to 80% by mass, and particularly preferably 60% to 70% by mass. In addition, among the (meth)acrylic compounds (M1), the content of the constitutional component derived from the (meth)acrylonitrile compound is set within the above range; however, it is preferably 5% to 80% by mass, more preferably 10% to 75% by mass, and still more preferably 10% to 50% by mass.

The content of the constitutional component derived from the vinyl compound (excluding the constitutional component represented by Formula (LF) or Formula (LS)) is set to 50% by mass or less, and it is preferably 0% to 40% by mass and more preferably 5% to 35% by mass. The content of the constitutional component derived from the styrene compound among the vinyl compounds is set in the above range; however, it is preferably 0% to 45% by mass and more preferably 10% to 35% by mass.

The content of the constitutional component derived from the ethylenically unsaturated monomer having a fluorine atom or a silicon atom is, for example, preferably 5% to 60% by mass, more preferably 10% to 50% by mass, and still more preferably 15% to 40% by mass. Among the above, the content of the constitutional component represented by Formula (LF) or Formula (LS) and incorporated in the main chain of the (meth)acrylic polymer is set within the above-described range; however, for example, preferably 5% to 60% by mass, more preferably 10% to 55% by mass, and more preferably 15% to 50% by mass.

The content of the constitutional component derived from the macromonomer is, for example, preferably 5% to 40% by mass, more preferably 10% to 35% by mass, and still more preferably 15% to 30% by mass. However, in a case where the constitutional component derived from the macromonomer includes, in the polymerized chain thereof, a constitutional component derived from an ethylenically unsaturated monomer having a fluorine atom or a silicon atom, the content of the constitutional component derived from the macromonomer is included in “the content of the constitutional component derived from the ethylenically unsaturated monomer having a fluorine atom or a silicon atom” described above.

The chain polymerization polymer (each constitutional component and raw material compound) may have a substituent. The substituent is not particularly limited; however, examples thereof preferably include a group selected from the following substituent Z.

—Substituent Z—

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, andoleyl), an alkynyl group (preferably an alkynyl group having 2 to 20 carbon atoms, for example, ethynyl, butadynyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present specification, the alkyl group generally has a meaning including a cycloalkyl group therein when being referred to, however, it will be described separately here), an aryl group (preferably an aryl group having 6 to 26 carbon atoms, such as phenyl, 1-naphthyl, 4-methoxyphenyl, 2-chlorophenyl, and 3-methylphenyl), an aralkyl group (preferably an aralkyl group having 7 to 23 carbon atoms, for example, benzyl or phenethyl), and a heterocyclic group (preferably a heterocyclic group having 2 to 20 carbon atoms and more preferably a 5- or 6-membered heterocyclic group having at least one oxygen atom, one sulfur atom, or one nitrogen atom,

where the heterocyclic group includes an aromatic heterocyclic group and an aliphatic heterocyclic group, and examples thereof include a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, and a pyrrolidone group); an alkoxy group (preferably an alkoxy group having 1 to 20 carbon atoms, for example, a methoxy group, an ethoxy group, an isopropyloxy group, or a benzyloxy group); an aryloxy group (preferably an aryloxy group having 6 to 26 carbon atoms, for example, a phenoxy group, a 1-naphthyloxy group, a 3-methylphenoxy group, or a 4-methoxyphenoxy group; in the present specification, the aryloxy group has a meaning including an aryloyloxy group therein when being referred to); a heterocyclic oxy group (a group in which an —O— group is bonded to the above-described heterocyclic group), an alkoxycarbonyl group (preferably an alkoxycarbonyl group having 2 to 20 carbon atoms, for example, an ethoxycarbonyl group, a 2-ethylhexyloxycarbonyl group, or a dodecyloxycarbonyl group); an aryloxycarbonyl group (preferably an aryloxycarbonyl group having 6 to 26 carbon atoms, for example, a phenoxycarbonyl group, a 1-naphthyloxycarbonyl group, a 3-methylphenoxycarbonyl group, or a 4-methoxyphenoxycarbonyl group); a heterocyclicoxycarbonyl group (a group in which an —O—CO— group is bonded to the heterocyclic group); an amino group (preferably an amino group having 0 to 20 carbon atoms, an alkylamino group, or an arylamino group, for example, an amino (—NH2) group, an N,N-dimethylamino group, an N,N-diethylamino group, an N-ethylamino group, or an anilino group); a sulfamoyl group (preferably a sulfamoyl group having 0 to 20 carbon atoms, for example, an N,N-dimethylsulfamoyl group or an N-phenylsufamoyl group); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, an acetyl group, a propionyl group, a butyryl group, an octanoyl group, a hexadecanoyl group, an acryloyl group, a methacryloyl group, a crotonoyl group, a benzoyl group, a naphthoyl group, or a nicotinoyl group); an acyloxy group (an alkylcarbonyloxy group, an alkenylcarbonyloxy group, an alkynylcarbonyloxy group, an arylcarbonyloxy group, or a heterocyclic carbonyloxy group, preferably an acyloxy group having 1 to 20 carbon atoms, for example, an acetyloxy group, a propionyloxy group, a butyryloxy group, an octanoyloxy group, a hexadecanoyloxy group, an acryloyloxy group, a methacryloyloxy group, a crotonoyloxy group, a benzoyloxy group, a naphthoyloxy group, or a nicotinoyloxy group); an aryloyloxy group (preferably an aryloyloxy group having 7 to 23 carbon atoms, for example, a benzoyloxy group); a carbamoyl group (preferably a carbamoyl group having 1 to 20 carbon atoms, for example, an N,N-dimethylcarbamoyl group or an N-phenylcarbamoyl group); an acylamino group (preferably an acylamino group having 1 to 20 carbon atoms, for example, an acetylamino group or a benzoylamino group); an alkylthio group (preferably an alkylthio group having 1 to 20 carbon atoms, for example, a methylthio group, an ethylthio group, an isopropylthio group, or a benzylthio group); an arylthio group (preferably an arylthio group having 6 to 26 carbon atoms, for example, a phenylthio group, a 1-naphthylthio group, a 3-methylphenylthio group, or a 4-methoxyphenylthio group); a heterocyclic thio group (a group in which an —S— group is bonded to the above-described heterocyclic group), an alkylsulfonyl group (preferably an alkylsulfonyl group having 1 to 20 carbon atoms, for example, a methylsulfonyl group or an ethylsulfonyl group), an arylsulfonyl group (preferably an arylsulfonyl group having 6 to 22 carbon atoms, for example, a benzenesulfonyl group), an alkylsilyl group (preferably an alkylsilyl group having 1 to 20 carbon atoms, for example, a monomethylsilyl group, a dimethylsilyl group, a trimethylsilyl group, or a triethylsilyl group); an arylsilyl group (preferably an arylsilyl group having 6 to 42 carbon atoms, for example, a triphenylsilyl group), an alkoxysilyl group (preferably an alkoxysilyl group having 1 to 20 carbon atoms, for example, a monomethoxysilyl group, a dimethoxysilyl group, a trimethoxysilyl group, or a triethoxysilyl group), an aryloxysilyl group (preferably an aryloxysilyl group having 6 to 42 carbon atoms, for example, a triphenyloxysilyl group), a phosphoryl group (preferably a phosphate group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a phosphate group (preferably a phosphate group having 0 to 20 carbon atoms, for example, —PO(OR)₂), a sulfo group (a sulfonate group), a carboxy group, a hydroxy group, a sulfanyl group, a cyano group, and a halogen atom (for example, a fluorine atom, a chlorine atom, a bromine atom, or an iodine atom).

R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

The chain polymerization polymer can be synthesized by selecting a raw material compound and polymerizing the raw material compound according to a known method.

Specific examples of the binder forming polymer include those shown below in addition to those synthesized in Examples; however, the present invention is not limited thereto. In each specific example, the number attached at the bottom right of the constitutional component indicates the content in the polymer, where the unit thereof is % by mass. It is noted that in the following specific example, Me represents a methyl group, and a “(constitutional component)-b-(constitutional component)” represents a block polymer consisting of blocks of respective constitutional components.

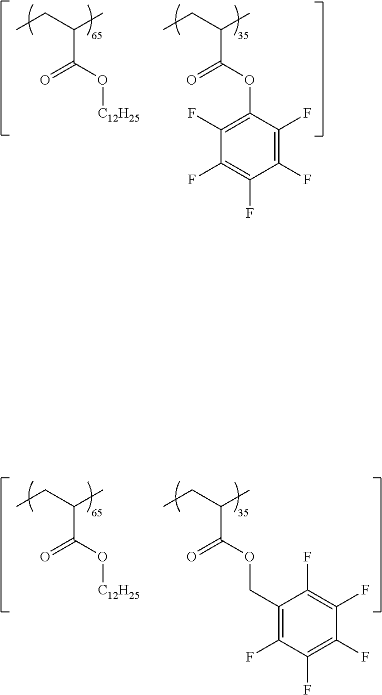

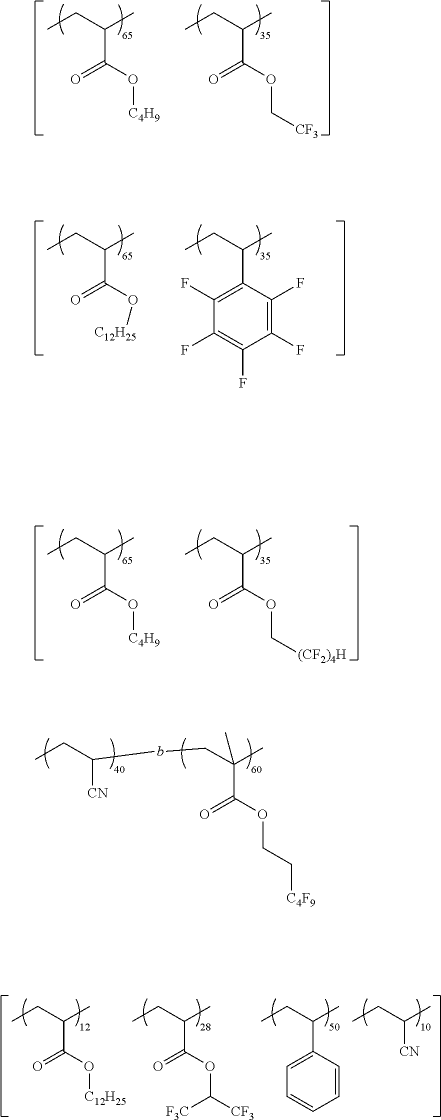

The inorganic solid electrolyte-containing composition may contain one kind or two or more kinds of binders.

The content of the binder in the inorganic solid electrolyte-containing composition is not particularly limited. However, from the viewpoints of dispersibility, ion conductivity, and furthermore adhesiveness, it is preferably 0.1% to 10.0% by mass, more preferably 0.5% to 9.0% by mass, and still more preferably 1.0% to 8.0% by mass, with respect to 100% by mass of the solid content. In a case where the inorganic solid electrolyte-containing composition contains an active material, the content of the binder in 100% by mass of the solid content is preferably 0.1% to 10.0% by mass, more preferably 0.2% to 5.0% by mass, still more preferably 0.3% to 4.0% by mass, and particularly preferably 0.5% to 2.0% by mass.

In the present invention, the mass ratio [(the mass of the inorganic solid electrolyte+the mass of the active material)/(the total mass of the binder)] of the total mass (the total amount) of the inorganic solid electrolyte and the active material to the mass of the binder in 100% by mass of the solid content is preferably in a range of 1,000 to 1. Furthermore, this ratio is more preferably 500 to 2 and still more preferably 100 to 10.

<Dispersion Medium>

It suffices that the dispersion medium contained in the inorganic solid electrolyte-containing composition is an organic compound that is in a liquid state in the use environment, examples thereof include various organic solvents, and specific examples thereof include an alcohol compound, an ether compound, an amide compound, an amine compound, a ketone compound, an aromatic compound, an aliphatic compound, a nitrile compound, and an ester compound.

The dispersion medium may be a non-polar dispersion medium (a hydrophobic dispersion medium) or a polar dispersion medium (a hydrophilic dispersion medium); however, a non-polar dispersion medium is preferable from the viewpoint that excellent dispersibility can be exhibited. The non-polar dispersion medium generally refers to a dispersion medium having a property of a low affinity to water; however, in the present invention, examples thereof include an ester compound, a ketone compound, an ether compound, an aromatic compound, and an aliphatic compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, diethylene glycol monomethyl ether, propylene glycol monomethyl ether, dipropylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, F-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, xylene, and perfluorotoluene.

Examples of the aliphatic compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

From the viewpoint of enhancing the affinity to a binder to improve the dispersibility of the solid particles, the dispersion medium preferably has an SP value (MPa^{1/2}) of 14 to 24, more preferably 15 to 22, and still more preferably 16 to 20. The difference (in terms of absolute value) in SP value between the dispersion medium and the binder forming polymer that is not particularly limited; however, from the viewpoint of further enhancing the dispersibility of the binder in the dispersion medium, it is preferably 3 or less, more preferably 0 to 2, and still more preferably 0 to 1.

The SP value of the dispersion medium is defined as a value obtained by converting the SP value calculated according to the Hoy method described above into the unit of MPa^{1/2}. In a case where the inorganic solid electrolyte-containing composition contains two or more kinds of dispersion media, the SP value of the dispersion medium means the SP value of the entire dispersion media, and it is the sum of the products of the SP values and the mass fractions of the respective dispersion media. Specifically, the calculation is carried out in the same manner as the above-described method of calculating the SP value of the polymer, except that the SP value of each of the dispersion media is used instead of the SP value of the constitutional component.

The SP values (the unit is omitted) of the main dispersion media are shown below.

MIBK (18.4), diisopropyl ether (16.8), dibutyl ether (17.9), diisopropyl ketone (17.9), DIBK (17.9), butyl butyrate (18.6), butyl acetate (18.9), toluene (18.5), ethylcyclohexane (17.1), cyclooctane (18.8), isobutyl ethyl ether (15.3), N-methylpyrrolidone (NMP, SP value: 25.4), perfluorotoluene (SP value: 13.4)

The dispersion medium preferably has a boiling point of 50° C. or higher and more preferably 70° C. or higher at normal pressure (1 atm). The upper limit thereof is preferably 250° C. or lower and more preferably 220° C. or lower.

The inorganic solid electrolyte-containing composition may contain one kind or two or more kinds of dispersion media.

In the present invention, the content of the dispersion medium in the inorganic solid electrolyte-containing composition is not particularly limited and can be appropriately set. For example, in the inorganic solid electrolyte-containing composition, it is preferably 20% to 80% by mass, more preferably 30% to 70% by mass, and particularly preferably 40% to 60% by mass.

<Active Material>

The inorganic solid electrolyte-containing composition according to the embodiment of the present invention can also contain an active material capable of intercalating and deintercalating an ion of a metal belonging to Group 1 or Group 2 of the periodic table. Examples of such active materials include a positive electrode active material and a negative electrode active material, which will be described later.

In the present invention, the inorganic solid electrolyte-containing composition containing an active material (a positive electrode active material or a negative electrode active material) may be referred to as an electrode composition (a positive electrode composition or a negative electrode composition).

(Positive Electrode Active Material)

The positive electrode active material is preferably a positive electrode active material capable of reversibly intercalating and deintercalating lithium ions. The above-described material is not particularly limited as long as the material has the above-described characteristics and may be a transition metal oxide or an element, which is capable of being complexed with Li, such as sulfur or the like by disassembling the battery.

Among the above, as the positive electrode active material, transition metal oxides are preferably used, and transition metal oxides having a transition metal element M^{a} (one or more elements selected from Co, Ni, Fe, Mn, Cu, or V) are more preferable. In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount thereof is preferably 0% to 30% by mole of the amount (100% by mole) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]),

LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄(LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include an iron fluorophosphate such as Li₂FePO₄F, a manganese fluorophosphate such as Li₂MnPO₄F, a cobalt fluorophosphate such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The shape of the positive electrode active material is not particularly limited but is preferably a particle shape. The particle diameter (the volume average particle diameter) of the positive electrode active material is not particularly limited. For example, it can be set to 0.1 to 50 μm. The particle diameter of the positive electrode active material particle can be measured using the same method as that of the particle diameter of the inorganic solid electrolyte. In order to allow the positive electrode active material to have a predetermined particle diameter, a general pulverizer or classifier is used. For example, a mortar, a ball mill, a sand mill, a vibration ball mill, a satellite ball mill, a planetary ball mill, a swirling air flow jet mill, or a sieve is preferably used. During pulverization, it is also possible to carry out wet-type pulverization in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

A positive electrode active material obtained using a baking method may be used after being washed with water, an acidic aqueous solution, an alkaline aqueous solution, or an organic solvent.

The positive electrode active material may be used singly, or two or more thereof may be used in combination.

The content of the positive electrode active material in the inorganic solid electrolyte-containing composition is not particularly limited; however, it is preferably 10% to 97% by mass, more preferably 30% to 95% by mass, still more preferably 40% to 93% by mass, and particularly preferably 50% to 90% by mass, in 100% by mass of the solid content.

(Negative Electrode Active Material)

The negative electrode active material is an active material capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material that is capable of forming an alloy (capable of being alloyed) with lithium. Among the above, a carbonaceous material, a metal composite oxide, or a lithium single body is preferably used from the viewpoint of reliability. An active material that is capable of being alloyed with lithium is preferable since the capacity of the all-solid state secondary battery can be increased. In the constitutional layer formed of the solid electrolyte composition according to the embodiment of the present invention, solid particles firmly bind to each other, and thus a negative electrode active material capable of forming an alloy with lithium can be used as the negative electrode active material. As a result, it is possible to increase the capacity of the all-solid state secondary battery and extend battery life.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the lattice spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that can be used as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are more preferably amorphous oxides, and preferred examples thereof include chalcogenides which are reaction products between metal elements and elements in Group 16 of the periodic table). In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “amorphous” represents an oxide having a broad scattering band with an apex in a range of 200 to 400 in terms of 20 value in case of being measured by an X-ray diffraction method using CuKα rays, and the oxide may have a crystalline diffraction line. The highest intensity in a crystalline diffraction line observed in a range of 40° to 70° in terms of 20 value is preferably 100 times or less and more preferably 5 times or less with respect to the intensity of a diffraction line at the apex in a broad scattering band observed in a range of 20° to 40° in terms of 2θ value, and it is still more preferable that the oxide does not have a crystalline diffraction line.

In the compound group consisting of the amorphous oxides and the chalcogenides, amorphous oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are more preferable. Specific examples of the preferred amorphous oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Preferred examples of the negative electrode active material which can be used in combination with a amorphous oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume variation during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is typically used as a negative electrode active material for a secondary battery, and examples thereof include a lithium aluminum alloy.

The negative electrode active material capable of forming an alloy with lithium is not particularly limited as long as it is typically used as a negative electrode active material for a secondary battery. Such an active material has a large expansion and contraction due to charging and discharging of the all-solid state secondary battery and accelerates the deterioration of the cycle characteristics. However, since the inorganic solid electrolyte-containing composition according to the embodiment of the present invention contains the polymer binder described above, and thus it is possible to suppress the deterioration of the cycle characteristics. Examples of such an active material include a (negative electrode) active material (an alloy or the like) having a silicon element or a tin element and a metal such as Al or In, a negative electrode active material (a silicon-containing active material) having a silicon element capable of exhibiting high battery capacity is preferable, and a silicon-containing active material in which the content of the silicon element is 50% by mole or more with respect to all the constitutional elements is more preferable.

In general, a negative electrode including the negative electrode active material (for example, an Si negative electrode including a silicon-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage that the battery driving duration can be extended.

Examples of the silicon-containing active material include a silicon-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including tin element include Sn, SnO, SnO₂, SnS, SnS₂, and the above-described active material including silicon element and tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is more preferable to include a negative electrode active material containing silicon (Si) or a silicon-containing alloy.

The chemical formulae of the compounds obtained by the above baking method can be calculated using an inductively coupled plasma (ICP) emission spectroscopy as a measuring method from the mass difference of powder before and after baking as a convenient method.

The shape of the negative electrode active material is not particularly limited but is preferably a particle shape. The volume average particle diameter of the negative electrode active material is not particularly limited; however, it is preferably 0.1 to 60 μm. The volume average particle diameter of the negative electrode active material particles can be measured using the same method as that of the particle diameter of the inorganic solid electrolyte. In order to obtain the predetermined particle diameter, a typical pulverizer or classifier is used as in the case of the positive electrode active material.

The negative electrode active material may be used singly, or two or more negative electrode active materials may be used in combination.

The content of the negative electrode active material in the inorganic solid electrolyte-containing composition is not particularly limited, and it is preferably 10% to 90% by mass, more preferably 20% to 85% by mass, still more preferably 30% to 80% by mass, and even still more preferably 40% to 75% by mass, in 100% by mass of the solid content.

In the present invention, in a case where a negative electrode active material layer is formed by charging a secondary battery, ions of a metal belonging to Group 1 or Group 2 in the periodic table, generated in the all-solid state secondary battery, can be used instead of the negative electrode active material. By bonding the ions to electrons and precipitating a metal, a negative electrode active material layer can be formed.

(Coating of Active Material)

The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or negative electrode active material may be subjected to a surface treatment with sulfur or phosphorus.

Further, the particle surface of the positive electrode active material or negative electrode active material may be subjected to a surface treatment with an actinic ray or an active gas (plasma or the like) before and after the surface coating.

<Conductive Auxiliary Agent>

The inorganic solid electrolyte-containing composition according to the embodiment of the present invention preferably contains a conductive auxiliary agent, and for example, it is preferable that the silicon atom-containing active material as the negative electrode active material is used in combination with a conductive auxiliary agent.

The conductive auxiliary agent is not particularly limited, and conductive auxiliary agents that are known as ordinary conductive auxiliary agents can be used. It may be, for example, graphite such as natural graphite and artificial graphite, carbon black such as acetylene black, Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

One kind of conductive auxiliary agent may be contained, or two or more kinds thereof may be contained.

The shape of the conductive auxiliary agent is not particularly limited but is preferably a particle shape.

In a case where the inorganic solid electrolyte-containing composition according to the embodiment of the present invention contains a conductive auxiliary agent, the content of the conductive auxiliary agent in the inorganic solid electrolyte-containing composition is preferably 0% to 10% by mass in 100% by mass of the solid content.

<Lithium Salt>

The inorganic solid electrolyte-containing composition according to the embodiment of the present invention preferably contains a lithium salt (a supporting electrolyte) as well.

Generally, the lithium salt is preferably a lithium salt that is used for this kind of product and is not particularly limited. For example, lithium salts described in paragraphs 0082 to 0085 of JP2015-088486A are preferable.

In a case where the inorganic solid electrolyte-containing composition according to the embodiment of the present invention contains a lithium salt, the content of the lithium salt is preferably 0.1 part by mass or more and more preferably 5 parts by mass or more with respect to 100 parts by mass of the solid electrolyte. The upper limit thereof is preferably 50 parts by mass or less and more preferably 20 parts by mass or less.

<Dispersing Agent>

Since the above-described polymer binder functions as a dispersing agent as well, the inorganic solid electrolyte-containing composition according to the embodiment of the present invention may not contain a dispersing agent other than this polymer binder; however, it may contain a dispersing agent. A dispersing agent that is generally used for an all-solid state secondary battery can be appropriately selected and used as the dispersing agent. Generally, a compound intended for particle adsorption and steric repulsion and/or electrostatic repulsion is suitably used.

<Other Additives>

As components other than the respective components described above, the inorganic solid electrolyte-containing composition according to the embodiment of the present invention may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an antifoaming agent, a leveling agent, a dehydrating agent, or an antioxidant. The ionic liquid is contained in order to further improve the ion conductivity, and the known one in the related art can be used without particular limitation. In addition, a polymer other than the binding forming polymer described above, a typically used binder, or the like may be contained.

<Preparation of Inorganic Solid Electrolyte-Containing Composition>

The inorganic solid electrolyte-containing composition according to the embodiment of the present invention can be prepared, as a mixture and preferably as a slurry, by mixing an inorganic solid electrolyte, the above-described polymer binder, a dispersion medium, and preferably a dispersion medium and a conductive auxiliary agent, as well as a lithium salt and any other optionally constitutional components as appropriate, by using, for example, various mixers that are used generally. In a case of an electrode composition, an active material is further mixed.

The mixing method is not particularly limited, and it can be carried out using a known mixer such as a ball mill, a beads mill, a planetary mixer, a blade mixer, a roll mill, a kneader, a disc mill, a self-rotation type mixer, or a narrow gap type disperser. Each component may be mixed collectively or may be mixed sequentially. A mixing environment is not particularly limited; however, examples thereof include a dry air environment and an inert gas environment. In addition, the mixing conditions are not particularly limited and are appropriately set.

[Sheet for all-Solid State Secondary Battery]

A sheet for an all-solid state secondary battery according to the embodiment of the present invention is a sheet-shaped molded body with which a constitutional layer of an all-solid state secondary battery can be formed, and it includes various aspects depending on use applications thereof. Examples of thereof include a sheet that is preferably used in a solid electrolyte layer (also referred to as a solid electrolyte sheet for an all-solid state secondary battery) and a sheet that is preferably used in an electrode or a laminate of an electrode and a solid electrolyte layer (an electrode sheet for an all-solid state secondary battery). In the present invention, the variety of sheets described above will be collectively referred to as a sheet for an all-solid state secondary battery.

In the present invention, each layer constituting a sheet for an all-solid state secondary battery may have a monolayer structure or a multilayer structure.

In the sheet for an all-solid state secondary battery, the solid electrolyte layer or the active material layer on the base material is formed of the inorganic solid electrolyte-containing composition according to the embodiment of the present invention. As a result, in a case of using the sheet for an all-solid state secondary battery, in which the deterioration due to moisture is suppressed, as a solid electrolyte layer, an active material layer, or an electrode of an all-solid state secondary battery by appropriately peeling off a base material therefrom, it is possible to improve the cycle characteristics of the all-solid state secondary battery and furthermore, the ion conductivity even in a low temperature environment. In particular, in a case where an electrode sheet for an all-solid state secondary battery is incorporated into an all-solid state secondary battery as an electrode, the cycle characteristics can be further improved since an active material layer and a collector are firmly attached to each other.

It suffices that the solid electrolyte sheet for an all-solid state secondary battery according to the embodiment of the present invention is a sheet having a solid electrolyte layer, and it may be a sheet in which a solid electrolyte layer is formed on a base material or may be a sheet (a sheet from which the base material has been peeled off) that is formed of a solid electrolyte layer without including a base material. The solid electrolyte sheet for an all-solid state secondary battery may include another layer in addition to the solid electrolyte layer. Examples of the other layer include a protective layer (a stripping sheet), a collector, and a coating layer. The solid electrolyte layer included in the solid electrolyte sheet for an all-solid state secondary battery is preferably formed of the inorganic solid electrolyte-containing composition according to the embodiment of the present invention. The contents of the respective components in the solid electrolyte layer are not particularly limited; however, the contents are preferably the same as the contents of the respective components with respect to the solid content of the inorganic solid electrolyte-containing composition according to the embodiment of the present invention. The layer thickness of each layer that constitutes the solid electrolyte sheet for an all-solid state secondary battery is the same as the layer thickness of each layer described later in the all-solid state secondary battery.

The base material is not particularly limited as long as it can support the solid electrolyte layer, and examples thereof include a sheet body (plate-shaped body) formed of materials described later regarding the collector, an organic material, an inorganic material, or the like. Examples of the organic material include various polymers, and specific examples thereof include polyethylene terephthalate, polypropylene, polyethylene, and cellulose. Examples of the inorganic material include glass and ceramic.

It suffices that an electrode sheet for an all-solid state secondary battery according to the embodiment of the present invention (simply also referred to as an “electrode sheet”) is an electrode sheet including an active material layer, and it may be a sheet in which an active material layer is formed on a substrate (collector) or may be a sheet (a sheet from which the base material has been peeled off) that is formed of an active material layer without including a substrate. The electrode sheet is typically a sheet including the collector and the active material layer, and examples of an aspect thereof include an aspect including the collector, the active material layer, and the solid electrolyte layer in this order and an aspect including the collector, the active material layer, the solid electrolyte layer, and the active material layer in this order. The solid electrolyte layer and the active material layer included in the electrode sheet are preferably formed of the inorganic solid electrolyte-containing composition according to the embodiment of the present invention. The contents of the respective constitutional components in this solid electrolyte layer or active material layer are not particularly limited; however, the contents are preferably the same as the contents of the respective constitutional components with respect to the solid content of the inorganic solid electrolyte-containing composition (the electrode composition) according to the embodiment of the present invention. The thickness of each of the layers forming the electrode sheet according to the embodiment of the present invention is the same as the layer thickness of each of the layers described later regarding the all-solid state secondary battery. The electrode sheet according to the embodiment of the present invention may include the above-described other layer.

In the sheet for an all-solid state secondary battery according to the embodiment of the present invention, at least one layer of the solid electrolyte layer or the active material layer is formed of the inorganic solid electrolyte-containing composition according to the embodiment of the present invention. Therefore, the sheet for an all-solid state secondary battery according to the present invention, in which the deterioration due to moisture is suppressed, includes a constitutional layer that has low resistance and hardly deteriorates even in a low temperature environment. In a case of using this constitutional layer as a constitutional layer of an all-solid state secondary battery, it is possible to realize excellent cycle characteristics and excellent low resistance (high conductivity) of the all-solid state secondary battery. In particular, in the electrode sheet for an all-solid state secondary battery and the all-solid state secondary battery, in which the active material layer is formed of the inorganic solid electrolyte-containing composition according to the embodiment of the present invention, the active material layer and the collector exhibit firm adhesiveness, and thus it is possible to realize further improvement of the cycle characteristics.

It is noted that in a case where the sheet for an all-solid state secondary battery has a layer other than the active material layer or the solid electrolyte layer, which is formed by the manufacturing method for a sheet for an all-solid state secondary battery according to the embodiment of the present invention, a layer manufactured according to a conventional method using known materials can be used as this layer.

[Manufacturing Method for Sheet for all-Solid State Secondary Battery]

The manufacturing method for a sheet for an all-solid state secondary battery according to the embodiment of the present invention is not particularly limited, and the sheet can be manufactured by forming each of the above layers using the inorganic solid electrolyte-containing composition according to the embodiment of the present invention. Examples thereof include a method in which the film formation (the coating and drying) is carried out preferably on a substrate or a collector (another layer may be interposed) to form a layer (a coated and dried layer) consisting of an inorganic solid electrolyte-containing composition. This method makes it possible to produce a sheet for an all-solid state secondary battery having a substrate or a collector and having a coated and dried layer. In particular, in a case where a film of the inorganic solid electrolyte-containing composition according to the embodiment of the present invention is formed on a collector to produce a sheet for an all-solid state secondary battery, it is possible to strengthen the adhesion between the collector and the active material layer. Here, the coated and dried layer refers to a layer formed by carrying out coating with the inorganic solid electrolyte-containing composition according to the embodiment of the present invention and drying the dispersion medium (that is, a layer formed using the inorganic solid electrolyte-containing composition according to the embodiment of the present invention and consisting of a composition obtained by removing the dispersion medium from the inorganic solid electrolyte-containing composition according to the embodiment of the present invention). In the active material layer and the coated and dried layer, the dispersion medium may remain within a range where the effect of the present invention is not impaired, and the residual amount thereof, for example, in each of the layers may be 3% by mass or lower.

In the manufacturing method for a sheet for an all-solid state secondary battery according to the embodiment of the present invention, each of the steps such as coating and drying will be described in the following manufacturing method for an all-solid state secondary battery.

In the manufacturing method for a sheet for an all-solid state secondary battery according to the embodiment of the present invention, the coated and dried layer obtained as described above can be pressurized. The pressurizing condition and the like will be described later in the section of the manufacturing method for an all-solid state secondary battery.

In addition, in the manufacturing method for a sheet for an all-solid state secondary battery according to the embodiment of the present invention, the substrate, the protective layer (particularly stripping sheet), or the like can also be stripped.

[All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid state secondary battery according to the embodiment of the present invention is not particularly limited in the configuration as long as it has a solid electrolyte layer between the positive electrode active material layer and the negative electrode active material layer, and for example, a known configuration for an all-solid state secondary battery can be employed. The positive electrode active material layer is preferably formed on a positive electrode collector to configure a positive electrode. The negative electrode active material layer is preferably formed on a negative electrode collector to configure a negative electrode.

At least one layer of the negative electrode active material layer, the positive electrode active material layer, or the solid electrolyte layer is formed of the inorganic solid electrolyte-containing composition according to the embodiment of the present invention, and at least one of the solid electrolyte layer, the negative electrode active material layer, or the positive electrode active material layer is preferably formed of the inorganic solid electrolyte-containing composition according to the embodiment of the present invention. The all-solid state secondary battery of the present invention, in which at least one of the constitutional layers is formed of the inorganic solid electrolyte-containing composition of the present invention exhibits excellent cycle characteristics and a sufficient ion conductivity even in a low temperature environment without impairing the high ion conductivity in the normal temperature environment.

In the present invention, an aspect in which all of the layers are formed of the inorganic solid electrolyte-containing composition according to the aspect of the present invention is also one of the preferred aspects. In a case where the active material layer or the solid electrolyte layer is not formed of the inorganic solid electrolyte-containing composition according to the embodiment of the present invention, a known material in the related art can be used.

In the present invention, each constitutional layer (including a collector and the like) constituting an all-solid state secondary battery may have a monolayer structure or a multilayer structure.

<Positive Electrode Active Material Layer, Solid Electrolyte Layer, and Negative Electrode Active Material Layer>

In the active material layer or the solid electrolyte layer formed of the inorganic solid electrolyte-containing composition according to the embodiment of the present invention, the kinds of components to be contained and the contents thereof are preferably the same as the solid content of the inorganic solid electrolyte-containing composition according to the embodiment of the present invention.

The thickness of each of the negative electrode active material layer, the solid electrolyte layer, and the positive electrode active material layer is not particularly limited. In case of taking a dimension of a general all-solid state secondary battery into account, the thickness of each of the layers is preferably 10 to 1,000 μm and more preferably 20 μm or more and less than 500 μm. In the all-solid state secondary battery according to the embodiment of the present invention, the thickness of at least one layer of the positive electrode active material layer or the negative electrode active material layer is still more preferably 50 μm or more and less than 500 μm.

Each of the positive electrode active material layer and the negative electrode active material layer may include a collector on the side opposite to the solid electrolyte layer.

<Collector>

The positive electrode collector and the negative electrode collector are preferably an electron conductor.

In the present invention, either or both of the positive electrode collector and the negative electrode collector will also be simply referred to as the collector.

As a material that forms the positive electrode collector, not only aluminum, an aluminum alloy, stainless steel, nickel, or titanium but also a material (a material on which a thin film has been formed) obtained by treating the surface of aluminum or stainless steel with carbon, nickel, titanium, or silver is preferable. Among these, aluminum or an aluminum alloy is more preferable.

As a material that forms the negative electrode collector, aluminum, copper, a copper alloy, stainless steel, nickel, titanium, or the like, and further, a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the collector, a film sheet shape is typically used; however, it is also possible to use shapes such as a net shape, a punched shape, a lath body, a porous body, a foaming body, and a molded body of a fiber group.

The thickness of the collector is not particularly limited; however, it is preferably 1 to 500 μm. In addition, protrusions and recesses are preferably provided on the surface of the collector by carrying out a surface treatment.

<Other Configurations>

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

<Housing>

Depending on the use application, the all-solid state secondary battery according to the embodiment of the present invention may be used as the all-solid state secondary battery having the above-described structure as it is but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

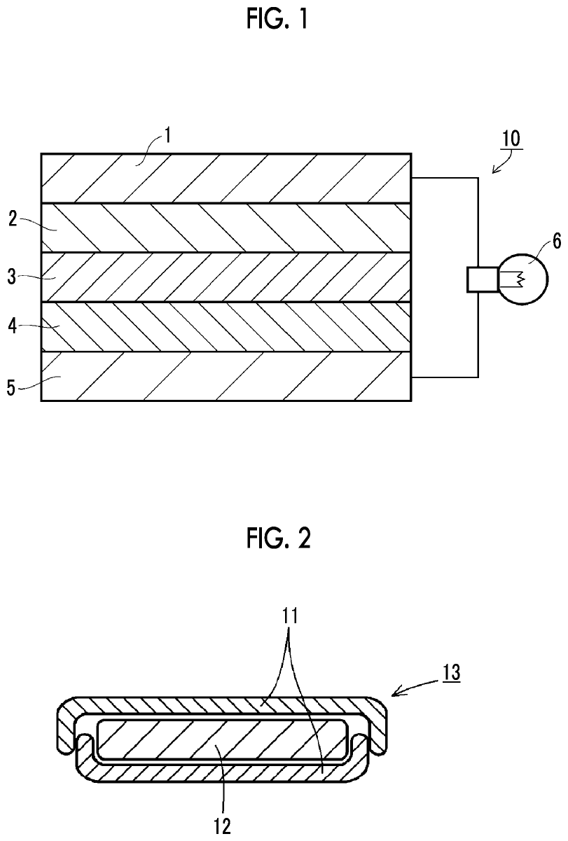

Hereinafter, the all-solid state secondary battery according to the preferred embodiments of the present invention will be described with reference to FIG. 1; however, the present invention is not limited thereto.

FIG. 1 is a cross-sectional view schematically illustrating an all-solid state secondary battery (a lithium ion secondary battery) according to a preferred embodiment of the present invention. In a case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode return to the positive electrode side, and electrons are supplied to an operation portion 6. In an example illustrated in the drawing, an electric bulb is employed as a model at the operation portion 6 and is lit by discharging.

In a case where the all-solid state secondary battery having a layer configuration illustrated in FIG. 1 is put into a 2032-type coin case, the all-solid state secondary battery will be referred to as the “laminate for an all-solid state secondary battery”, and a battery prepared by placing this laminate for an all-solid state secondary battery into a 2032-type coin case will be referred to as “all-solid state secondary battery”, thereby referring to both batteries distinctively in some cases.

(Positive Electrode Active Material Layer, Solid Electrolyte Layer, and Negative Electrode Active Material Layer)

In the all-solid state secondary battery 10, all of the positive electrode active material layer, the solid electrolyte layer, and the negative electrode active material layer are formed of the inorganic solid electrolyte-containing composition of the embodiment of the present invention. This all-solid state secondary battery 10 exhibits excellent battery performance. The kinds of the inorganic solid electrolyte and the polymer binder which are contained in the positive electrode active material layer 4, the solid electrolyte layer 3, and the negative electrode active material layer 2 may be identical to or different from each other.

In the present invention, any one of the positive electrode active material layer and the negative electrode active material layer, or collectively both of them may be simply referred to as an active material layer or an electrode active material layer. In addition, in the present invention, any one of the positive electrode active material and the negative electrode active material, or collectively both of them may be simply referred to as an active material or an electrode active material.

The solid electrolyte layer contains an inorganic solid electrolyte having an ion conductivity of a metal belonging to Group 1 or Group 2 in the periodic table, and a component described later within a range where the effect of the present invention is not impaired, and it generally does not contain a positive electrode active material and/or a negative electrode active material.

The positive electrode active material layer contains an inorganic solid electrolyte having an ion conductivity of a metal belonging to Group 1 or Group 2 in the periodic table, a positive electrode active material, and a component described later within a range where the effect of the present invention is not impaired.

The negative electrode active material layer contains an inorganic solid electrolyte having an ion conductivity of a metal belonging to Group 1 or Group 2 in the periodic table, a negative electrode active material, and a component described later within a range where the effect of the present invention is not impaired.

In the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 m regardless of the above thickness of the above negative electrode active material layer.

In the present invention, any one of the positive electrode active material layer and the negative electrode active material layer, or collectively both of them may be simply referred to as an active material layer or an electrode active material layer. In addition, in the present invention, any one of the positive electrode active material and the negative electrode active material, or collectively both of them may be simply referred to as an active material or an electrode active material.

(Collector)

The positive electrode collector 5 and the negative electrode collector 1 are as described above.

[Manufacture of all-Solid State Secondary Battery]

The all-solid state secondary battery can be manufactured by a conventional method. Specifically, the all-solid state secondary battery can be manufactured by forming each of the layers described above using the inorganic solid electrolyte-containing composition of the embodiment of the present invention or the like. Hereinafter, the manufacturing method therefor will be described in detail.

The all-solid state secondary battery according to the embodiment of the present invention can be manufactured by carrying out a method (a manufacturing method for a sheet for an all-solid state secondary battery according to the embodiment of the present invention) which includes (is carried out through) a step of coating an appropriate substrate (for example, a metal foil which serves as a collector) with the inorganic solid electrolyte-containing composition according to the embodiment of the present invention and forming a coating film (forming a film).

For example, an inorganic solid electrolyte-containing composition containing a positive electrode active material is applied and dried as a material for a positive electrode (a positive electrode composition) onto a metal foil which is a positive electrode collector, to form a positive electrode active material layer, thereby producing a positive electrode sheet for an all-solid state secondary battery. Next, the inorganic solid electrolyte-containing composition for forming a solid electrolyte layer is applied and dried onto the positive electrode active material layer to form the solid electrolyte layer. Furthermore, an inorganic solid electrolyte-containing composition containing a negative electrode active material is applied and dried as a material for a negative electrode (a negative electrode composition) onto the solid electrolyte layer, to form a negative electrode active material layer. A negative electrode collector (a metal foil) is superposed on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can also be manufactured by enclosing the all-solid state secondary battery in a housing.

In addition, it is also possible to manufacture an all-solid state secondary battery by carrying out the forming method for each layer in reverse order to form a negative electrode active material layer, a solid electrolyte layer, and a positive electrode active material layer on a negative electrode collector as a base material and superposing a positive electrode collector thereon.

Examples of the other method include the following method. That is, the positive electrode sheet for an all-solid state secondary battery is produced as described above. In addition, in the same manner, an inorganic solid electrolyte-containing composition containing a negative electrode active material is applied and dried as a material for a negative electrode collector (a negative electrode composition) onto the negative collector, to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

As still another method, for example, the following method can be used. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, an inorganic solid electrolyte-containing composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated with each other to sandwich the solid electrolyte layer that has been peeled off from the base material. In this manner, an all-solid state secondary battery can be manufactured.

Further, a positive electrode sheet for an all-solid state secondary battery, a negative electrode sheet for an all-solid state secondary battery, and a solid electrolyte sheet for an all-solid state secondary battery are produced as described above. Next, the positive electrode sheet for an all-solid state secondary battery or negative electrode sheet for an all-solid state secondary battery, and the solid electrolyte sheet for an all-solid state secondary battery are overlaid and pressurized into a state where the positive electrode active material layer or the negative electrode active material layer is brought into contact with the solid electrolyte layer. In this way, the solid electrolyte layer is transferred to the positive electrode sheet for an all-solid state secondary battery or the negative electrode sheet for an all-solid state secondary battery. Then, the solid electrolyte layer from which the base material of the solid electrolyte sheet for an all-solid state secondary battery has been peeled off and the negative electrode sheet for an all-solid state secondary battery or positive electrode sheet for an all-solid state secondary battery are overlaid and pressurized (into a state where the negative electrode active material layer or positive electrode active material layer is brought into contact with the solid electrolyte layer). In this way, an all-solid state secondary battery can be manufactured. The pressurizing method and the pressurizing conditions in this method are not particularly limited, and a method and pressurizing conditions described in the pressurization step, which will be described later, can be applied.

The solid electrolyte layer or the like can also be formed by, for example, forming an inorganic solid electrolyte-containing composition or the like on a substrate or an active material layer by pressurization molding under pressurizing conditions described later.

In the above production method, it suffices that the inorganic solid electrolyte-containing composition according to the embodiment of the present invention is used in any one of the positive electrode composition, the inorganic solid electrolyte-containing composition, or the negative electrode composition. The inorganic solid electrolyte-containing composition according to the embodiment of the present invention is preferably used in the inorganic solid electrolyte-containing composition or at least one of the positive electrode composition or the negative electrode composition, or the inorganic solid electrolyte-containing composition according to the embodiment of the present invention can be used in any of the compositions.

<Formation of Individual Layer (Film Formation)>

The method of applying the inorganic solid electrolyte-containing composition is not particularly limited and can be appropriately selected. Examples thereof include wet-type coating methods such as spray coating, spin coating, dip coating, slit coating, stripe coating, and bar coating.

In this case, the inorganic solid electrolyte-containing composition may be dried after being applied each time or may be dried after being applied multiple times. The drying temperature is not particularly limited. The lower limit thereof is preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the solid electrolyte composition is heated in the above-described temperature range, the dispersion medium can be removed to make the composition enter a solid state (coated and dried layer). This temperature range is preferable since the temperature is not excessively increased and each member of the all-solid state secondary battery is not impaired. As a result, excellent overall performance is exhibited in the all-solid state secondary battery, and it is possible to obtain a good binding property and a good ion conductivity even without pressurization.

In a case where the inorganic solid electrolyte-containing composition according to the embodiment of the present invention is applied and dried as described above, it is possible to suppress the variation in the contact state and bind solid particles, and furthermore, it is possible to form a coated and dried layer having a flat surface.

After applying the inorganic solid electrolyte-containing composition, it is preferable to pressurize each layer or the all-solid state secondary battery after superimposing the constitutional layers or producing the all-solid state secondary battery. In addition, each of the layers is also preferably pressurized together in a state of being laminated. Examples of the pressurizing methods include a method using a hydraulic cylinder press machine. The pressurizing force is not particularly limited; however, it is generally preferably in a range of 5 to 1,500 MPa.

In addition, the applied inorganic solid electrolyte-containing composition may be heated at the same time with the pressurization. The heating temperature is not particularly limited but is generally in a range of 30° C. to 300° C. The press can also be applied at a temperature higher than the glass transition temperature of the inorganic solid electrolyte. It is also possible to carry out press at a temperature higher than the glass transition temperature of the polymer contained in the polymer binder. However, in general, the temperature does not exceed the melting point of this polymer.

The pressurization may be carried out in a state where the coating solvent or dispersion medium has been dried in advance or in a state where the solvent or the dispersion medium remains.

The respective compositions may be applied at the same time, and the application, the drying, and the pressing may be carried out simultaneously and/or sequentially. Each of the compositions may be applied onto each of the separate substrates and then laminated by carrying out transfer.

The atmosphere in the film forming method (coating, drying, and pressurization (under heating) is not particularly limited and may be any one of the atmospheres such as an atmosphere of dried air (the dew point: −20° C. or lower) and an atmosphere of inert gas (for example, an argon gas, a helium gas, or a nitrogen gas).

The pressurization time may be a short time (for example, within several hours) under the application of a high pressure or a long time (one day or longer) under the application of an intermediate pressure. In case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure may be variable depending on the area or the film thickness of the portion under pressure. In addition, the pressure may also be variable stepwise for the same portion.

A pressing surface may be flat or roughened.

<Initialization>

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure up to a pressure at which the all-solid state secondary battery is ordinarily used.

[Usages of all-Solid State Secondary Battery]

The all-solid state secondary battery according to the embodiment of the present invention can be applied to a variety of usages. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Furthermore, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto be interpreted. “Parts” and “%” that represent compositions in the following Examples are based on the mass unless particularly otherwise described. In the present invention, “room temperature” means 25° C.

The polymers used in Examples and Comparative Examples are shown below. The number at the bottom right of each constitutional component indicates the content (% by mass). In the following polymers, Me represents a methyl group, and wavy lines in polymers B-11 and T-5 indicate a bonding site to a polymerized chain.

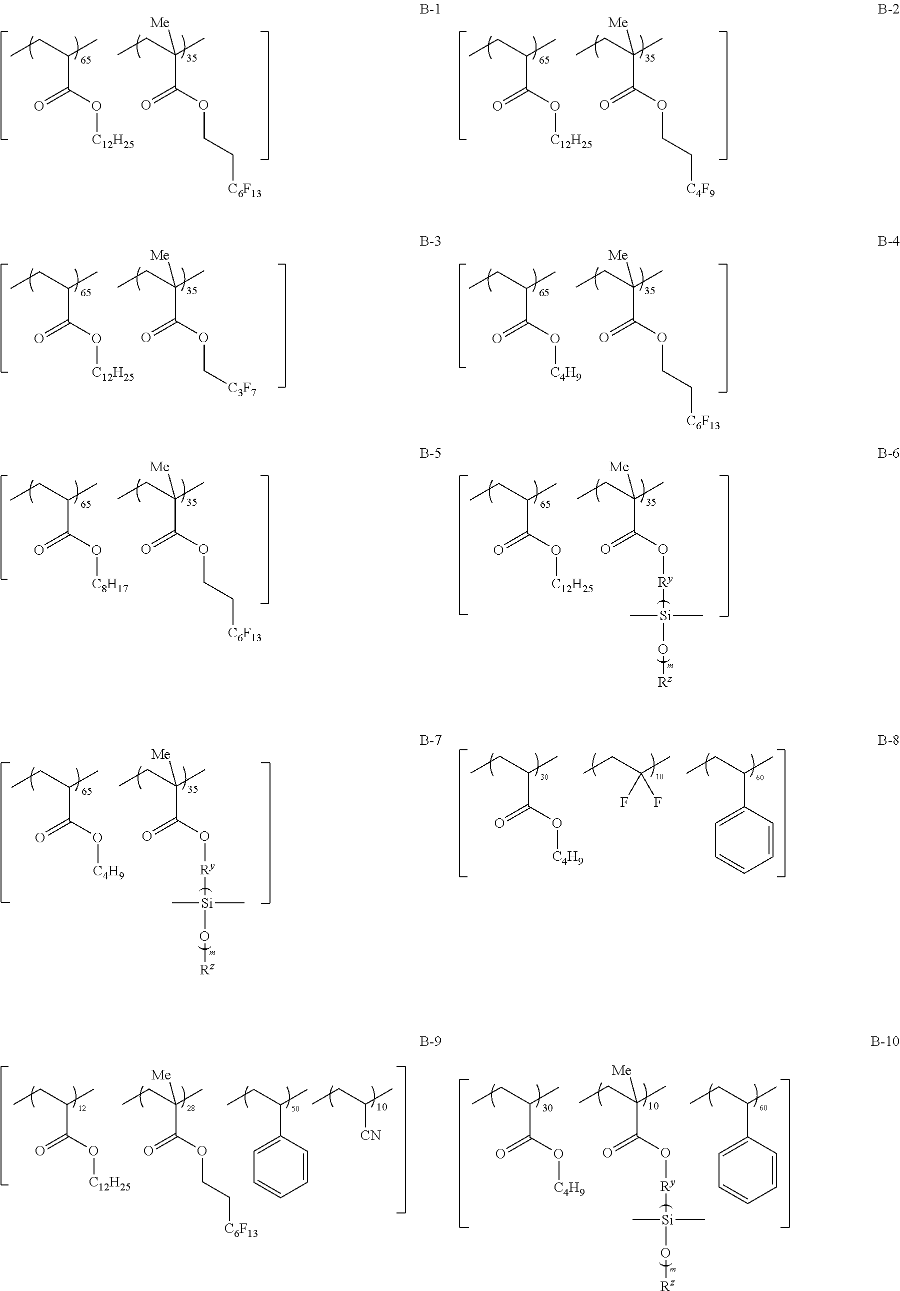

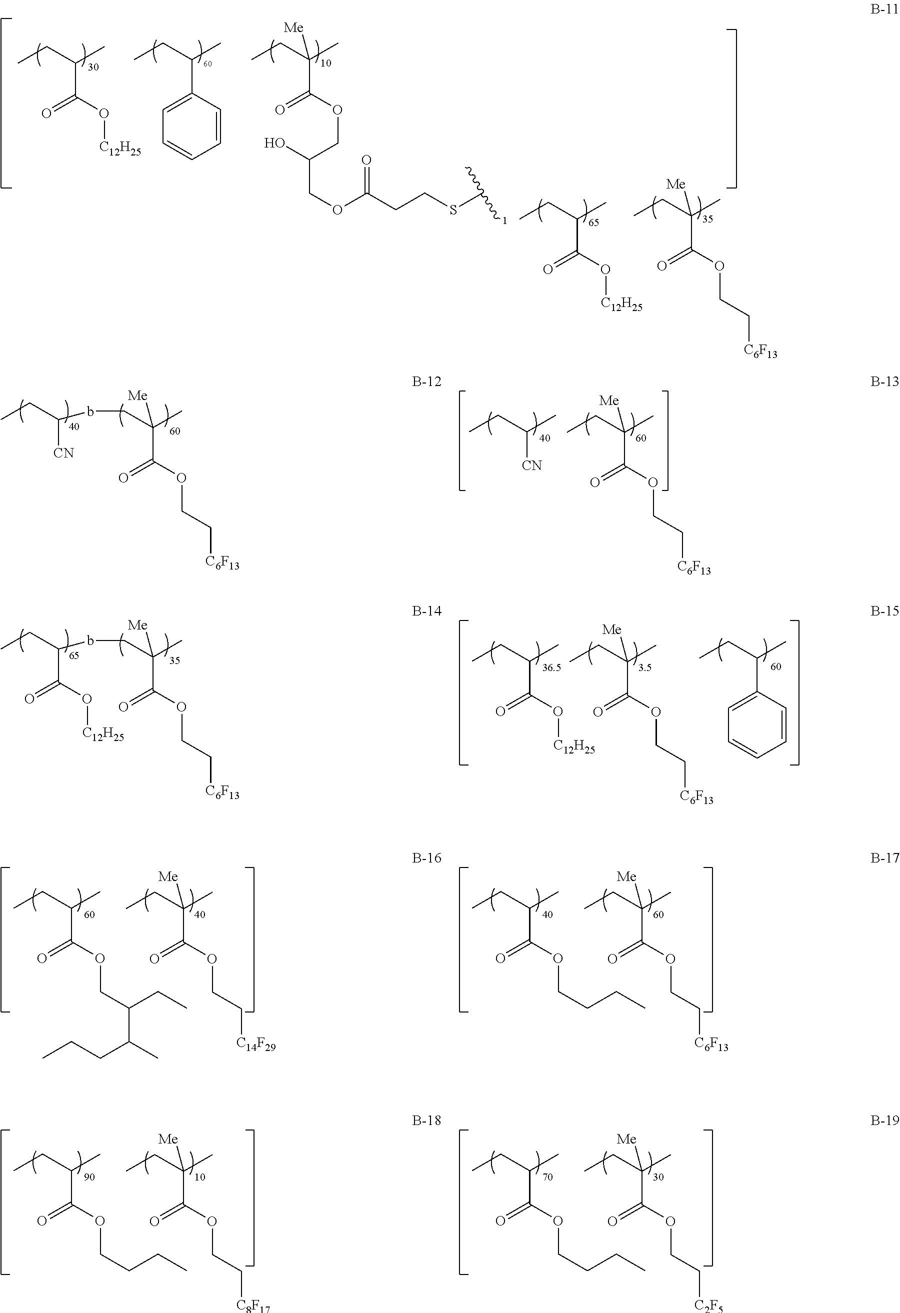

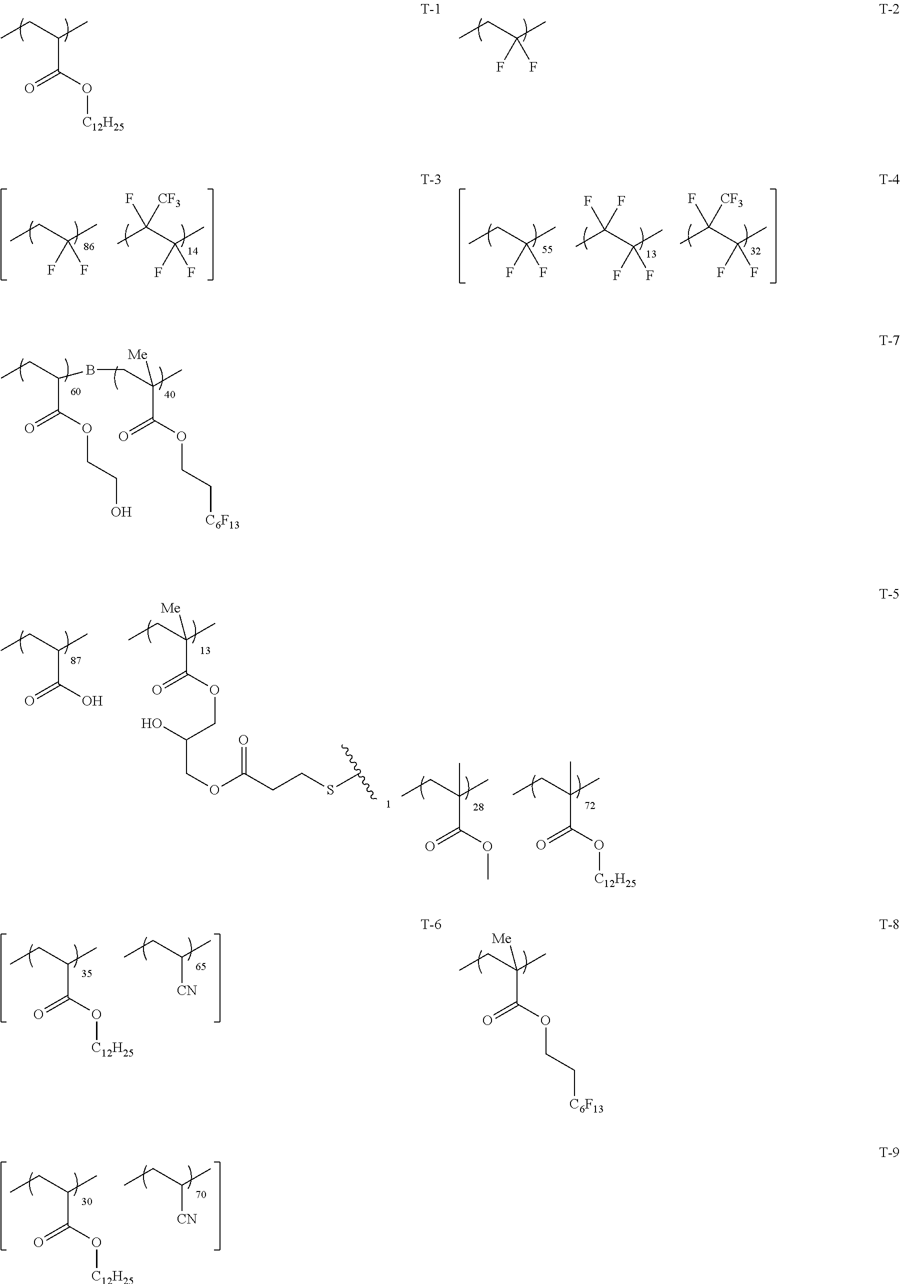

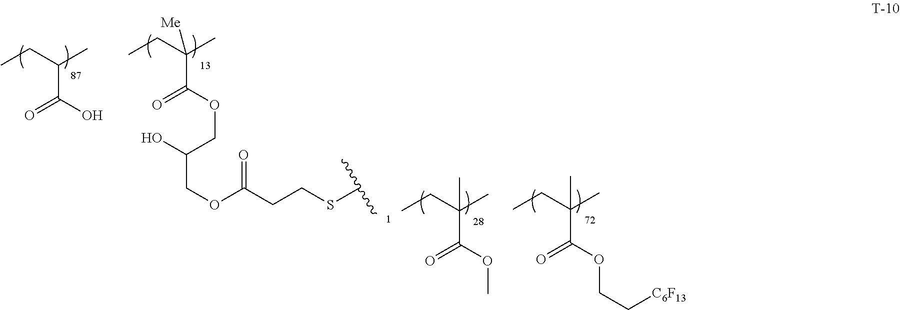

1. Polymer Synthesis and Preparation of Binder Solution or Binder Dispersion Liquid

Polymers having the above chemical formulae and polymers shown in Table 1 were synthesized as follows.

### Preparation Example 1: Synthesis of Polymer B-1 and Preparation of Binder Solution B-1

To a 100 mL graduated cylinder, 23.4 g of dodecyl acrylate, 12.6 g of 1H,1H,2H,2H-tridecafluorooctyl methacrylate, and 0.36 g of a polymerization initiator V-601 (product name, manufactured by FUJIFILM Wako Pure Chemical Corporation) were added and dissolved in 36.0 g of butyl butyrate to prepare a monomer solution B-1.

To a 300 mL three-necked flask, 18 g of butyl butyrate was added and stirred at 80° C., and then the above monomer solution B-1 was added dropwise thereto over 2 hours. After completion of the dropwise addition, the temperature was raised to 90° C., and stirring was carried out for 2 hours to synthesize a polymer B-1, thereby obtaining a binder solution B-1 (polymer concentration: 40% by mass) consisting of the (meth)acrylic polymer B-1.

### Preparation Examples 2 to 16: Synthesis of Polymers B-2 to B-7, B-13, B-16 to B-19, T-1, T-6, T-8, and T-9, and Preparation of Binder Solutions B-2 to B-7, B-13, B-16 to B-19, T-1, T-6, T-8, and T-9

(Meth)acrylic polymers or vinyl polymers B-2 to B-7, B-13, B-16 to B-19, T-1, T-6, T-8, and T-9 were synthesized in the same manner as in Preparation Example 1 to respectively prepare binder solutions B-2 to B-7, B-13, B-16 to B-19, T-1, T-6, T-8, and T-9 consisting of the respective polymers, except that in Preparation Example 1, compounds from which the respective constitutional components were derived was used so that the compositions of the polymers B-2 to B-7, B-13, B-16 to B-19, T-1, T-6, T-8, and T-9 respectively had the compositions (the kinds and the contents of the constitutional components) represented by the above-described chemical formulae.

It is noted that the macromonomer used in the (meth)acrylic polymers B-6 and B-7 is X-22-174BX (product name, manufactured by Shin-Etsu Chemical Co., Ltd.). In these macromonomers, R^{Y} is an alkylene group or an arylene group, R^{Z} is an alkyl group or an aryl group, and m is 25 to 35 (mass average molecular weight: 1,500 to 3,500).

### Preparation Example 17: Synthesis of Polymer B-8 and Preparation of Binder Solution B-8

10.0 g of butyl butyrate, 1.0 g of vinylidene fluoride, 3.0 g of butyl acrylate, and 6.0 g of styrene were added to an autoclave, 0.1 g of diisopropyl peroxydicarbonate was further added thereto, and the resultant mixture was stirred at 30° C. for 24 hours. After the completion of the polymerization reaction, the precipitate was filtered and dried at 100° C. for 10 hours to obtain a vinyl polymer B-8.

This vinyl polymer B-8 was dissolved in butyl butyrate to prepare a binder solution B-8 (polymer concentration: 40% by mass) consisting of the polymer B-8.

### Preparation Example 18: Synthesis of Polymer B-9 and Preparation of Binder Solution B-9

To a 100 mL graduated cylinder, 4.32 g of dodecyl acrylate, 10.1 g of 1H,1H,2H,2H-tridecafluorooctyl methacrylate, 18.00 g of styrene, and 3.6 g of acrylonitrile, and 0.36 g of a polymerization initiator V-601 (product name, manufactured by FUJIFILM Wako Pure Chemical Corporation) were added and dissolved in 36.0 g of butyl butyrate to prepare a monomer solution B-9.

To a 300 mL three-necked flask, 18 g of butyl butyrate was added and stirred at 80° C., and then the above monomer solution B-9 was added dropwise thereto over 2 hours. After completion of the dropwise addition, the temperature was raised to 90° C., and stirring was carried out for 2 hours to synthesize a polymer B-9, thereby obtaining a binder solution B-9 (polymer concentration: 40% by mass) consisting of the (meth)acrylic polymer B-9.

### Preparation Example 19: Synthesis of Polymer B-15 and Preparation of Binder Solution B-15

A (meth)acrylic polymer B-15 was synthesized in the same manner as in Preparation Example 18 to prepare a binder solution B-15 consisting of each polymer, except that in Preparation Example 18, a compound from which each constitutional component was derived was used so that the (meth)acrylic polymer B-15 had the composition (the kind and the content of the constitutional component) represented by the above chemical formula.

### Preparation Example 20: Synthesis of Polymer B-10 and Preparation of Binder Solution B-10

To a 100 mL graduated cylinder, 10.8 g of butyl acrylate, 21.6 g of styrene, 3.6 g a silicone macromonomer: X-22-174BX (product name), and 0.36 g of a polymerization initiator V-601 (product name, manufactured by FUJIFILM Wako Pure Chemical Corporation) were added and dissolved in 36.0 g of butyl butyrate to prepare a monomer solution B-10.

To a 300 mL three-necked flask, 18 g of butyl butyrate was added and stirred at 80° C., and then the above monomer solution B-10 was added dropwise thereto over 2 hours. After completion of the dropwise addition, the temperature was raised to 90° C., and stirring was carried out for 2 hours to synthesize a polymer B-10, thereby obtaining a binder solution B-10 (polymer concentration: 40% by mass) consisting of the vinyl polymer B-10.

### Preparation Example 21: Synthesis of Polymer B-11 and Preparation of Binder Solution B-11

To a 500 mL graduated cylinder, 136.6 g of dodecyl acrylate, 73.4 g of 1H,1H,2H,2H-tridecafluorooctyl acrylate, 3.85 g of 3-mercaptopropionic acid, and 4.20 g of a polymerization initiator V-601 (product name) were added and dissolved in 57.0 g of butyl butyrate to prepare a monomer solution B-11. To a 1,000 mL three-necked flask, 71.3 g of butyl butyrate was added and stirred at 80° C., and then the above monomer solution B-11 was added dropwise thereto over 2 hours, followed by further stirring at 80° C. for 2 hours. After further adding 0.42 g of the polymerization initiator V-601, the temperature was raised to 95° C., and stirring was further carried out for 2 hours. To the obtained solution, 6.2 g of glycidyl methacrylate, 0.2 g of 4-hydroxy-2,2,6,6-tetramethylpiperidin-1-oxyl free radical, and 2.6 g of tetrabutylammonium bromide were further added, and the resultant mixture was further stirred at 100° C. for 3 hours. The obtained reaction solution was reprecipitated with methanol to synthesize a macromonomer MM-11 (SP value: 17.6, number average molecular weight: 5,000).

Next, a vinyl polymer B-11 was synthesized in the same manner as in Preparation Example 1 to prepare a binder solution B-11 consisting of the vinyl polymer B-11, except that in Preparation Example 1, a compound from which each constitutional component was derived was used so that the vinyl polymer B-11 had the composition (the kind and the content of the constitutional component) represented by the above chemical formula.

### Preparation Examples 22 to 24: Synthesis of Polymers B-12, B-14, and T-7, and Preparation of Binder Solutions B-12, B-14, and T-7

According to Example 1 described in paragraphs 0101 and 0102 of 2011-054439A, respective block polymers of (meth)acrylic polymers B-12, B-14, and T-7 were synthesized by using a compound from which each constitutional component was derived so that the composition (the kind and the content of the constitutional component) represented by the above chemical formula was obtained.

The synthesized (meth)acrylic polymers B-12, B-14, and T-7 were dissolved in butyl butyrate to respectively prepare binder solutions B-12, B-14, and T-7 consisting of the polymers B-12, B-14, and T-7 (polymer concentration: 40% by mass).

### Preparation Examples 25 and 26: Synthesis of Polymers T-5 and T-10, and Preparation of Binder Dispersion Liquids T-5 and T-10

(Meth)acrylic polymers T-5 and T-10 were synthesized in the same manner as in Preparation Example 21, except that in Preparation Example 21, a compound from which each constitutional component was derived was used so that each of the (meth)acrylic polymer T-5 and T-10 had the composition (the kind and the content of the constitutional component) represented by the above chemical formula. The SP value of the macromonomer MM-2 synthesized with the polymer T-5 was 18.9, and the number average molecular weight thereof was 5,000. The SP value of the macromonomer MM-3 synthesized with the polymer T-10 was 15.9, and the number average molecular weight thereof was 5,000.

The synthesized polymers T-5 and T-10 were dispersed in butyl butyrate to respectively prepare binder dispersion liquids T-5 and T-10 consisting of the polymers T-5 and T-10 (both had a polymer concentration of 40% and an average particle diameter of 5 μm).

### Preparation Examples 27 to 29: Preparation of Binder Solutions T-2 to T-4

Fluoropolymers T-2 (product name: KF polymer, manufactured by Kureha Corporation), T-3 (product name: Tecnoflon (registered trade name) NH, manufactured by Solvay S.A.), T-4 (product name: Tecnoflon (registered trade name) TN, manufactured by Solvay S.A.) were dissolved in butyl butyrate to respectively prepare binder solutions T-2 to T-4 (polymer concentration: 40% by mass) consisting of the respective polymers.

Table 1 shows the surface energy, the SP value, and the elastic modulus of each synthesized polymer. The SP value of the polymer was measured according to the above-described method.

The surface energy was measured as follows.

Production of Polymer Film—

100 μL of the binder solution or binder dispersion liquid prepared above was applied onto a silicon wafer (3×N type, manufactured by AS ONE Corporation) with a spin coater under the following coating conditions, and then vacuum drying was carried out at 100° C. for 2 hours to produce a polymer film of each binder.

(Coating Conditions)

Concentration of binder solution: 40% by mass

Rotation speed of spin coater: 2,000 rpm

Rotation time of spin coater: 5 seconds

—Calculation of Surface Energy—

The contact angle θ of each of the diiodomethane and the water with respect to the polymer film produced on the silicon wafer as described above was measured according to the θ/2 method in the liquid droplet method. Here, an angle (an angle inside the liquid droplet), which was formed by the sample surface (the surface of the polymer film) and a liquid droplet after 200 milliseconds after the liquid droplet had been brought into contact with the surface of the polymer film and attached thereto, was defined as the contact angle θ.

A value calculated according to the following Owens method using each measured contact angle θ is used as the surface energy.

<Owens Method>

1+cos θH₂O=2√γSd(√γH₂Od/γH₂O,V)+2√γSh(√γH₂Oh/γH₂O,V)1+cos θCH₂I₂=2√γSd(√γCH₂I₂d/γCH₂I₂,V)+2√γSh(√γCH₂I₂h/γCH₂I₂,V)

The notations in the above expression are as follows.

θH₂O: Contact angle of water (°)

θCH₂I₂: Contact angle of diiodomethane (°)

γSd: Dispersion force component of surface energy of polymer (mN/m)

γH₂Od: Dispersion force component of surface energy of water (mN/m)

γH₂O, V: Total surface energy of water (mN/m)

γSh: Hydrogen bond component of surface energy of polymer (mN/m)

γH₂Oh: Hydrogen bond component of surface energy of water (mN/m)

γCH₂I₂d: Dispersion force component of surface energy of diiodomethane (mN/m)

γCH₂I₂, V: Total surface energy of diiodomethane (mN/m)

γCH₂I₂h: Hydrogen bond component of surface energy of diiodomethane (mN/m)

The elastic modulus was measured as follows.

—Preparation of Test Piece—

The binder solution or binder dispersion liquid prepared above was placed in a glass petri dish and dried at 120° C. for 6 hours to obtain a dried film having a film thickness of 80 m. The obtained dried film was cut into a striped shape having a width of 10 mm and a length of 40 mm to prepare a test piece.

—Measurement of Elastic Modulus—

Each prepared test piece was set in a force gauge (manufactured by IMADA Co., Ltd.) so that the distance between the chucks was 30 mm. In this state, the test piece was pulled at a rate of 10 mm/min, the displacement magnitude and the stress were measured, and the tensile elastic modulus was calculated from the initial slope.

TABLE 1

| | Surface | | Elastic | Mass average |
|---|---|---|---|---|
| Polymer | energy | SP value | modulus | molecular |
| No. | (mN/m) | (MPa^{1/2}) | (MPa) | weight |
| B-1 | 8.1 | 17.2 | 0.5 | 70,000 |
| B-2 | 8.3 | 17.4 | 0.5 | 80,000 |
| B-3 | 8.5 | 17.5 | 0.5 | 70,000 |
| B-4 | 8.6 | 17.7 | 0.5 | 60,000 |
| B-5 | 8.0 | 17.3 | 0.5 | 70,000 |
| B-6 | 8.8 | 18.4 | 0.5 | 90,000 |
| B-7 | 8.7 | 18.9 | 0.5 | 80,000 |
| B-8 | 19.2 | 18.8 | 1 | 80,000 |
| B-9 | 18.3 | 18.6 | 80 | 60,000 |
| B-10 | 18.2 | 19.2 | 80 | 60,000 |
| B-11 | 13.2 | 18.9 | 20 | 70,000 |
| B-12 | 13.1 | 19.2 | 10 | 70,000 |
| B-13 | 19.0 | 19.2 | 10 | 80,000 |
| B-14 | 8.1 | 17.2 | 0.5 | 80,000 |
| B-15 | 9.0 | 18.9 | 20 | 60,000 |
| B-16 | 8.2 | 16.4 | 0.5 | 70,000 |
| B-17 | 8.0 | 16.2 | 0.5 | 60,000 |
| B-18 | 11.0 | 19.0 | 0.6 | 80,000 |
| B-19 | 7.8 | 18.5 | 0.4 | 70,000 |
| T-1 | 23.5 | 18.8 | 0.5 | 60,000 |
| T-2 | 16.2 | 13.1 | 400 | 60,000 |
| T-3 | 16.3 | 12.6 | 60 | 70,000 |
| T-4 | 16.5 | 11.4 | 5 | 70,000 |
| T-5 | 34.3 | 20.3 | 15 | 80,000 |
| T-6 | 25.0 | 23.2 | 15 | 60,000 |
| T-7 | 19.0 | 21.8 | 0.8 | 60,000 |
| T-8 | 10.2 | 13.6 | 0.5 | 60,000 |
| T-9 | 29.0 | 23.5 | 200 | 60,000 |
| T-10 | 12.3 | 19.9 | 18 | 70,000 |

The SP values as the constitutional components of the raw material compounds used in the synthesis of the polymers are shown below.

Dodecyl acrylate: 18.8 MVPa^{1/2}

1H,1H,2H,2H-tridecafluorooctyl methacrylate: 13.7 MPa^{1/2}

1H,1H,2H,2H-nonafluorohexyl methacrylate: 14.5 MPa^{1/2}

1H,1H-heptafluorobutyl methacrylate: 14.8 MPa^{1/2}

Butyl acrylate: 19.5 MPa^{1/2}

Octyl acrylate: 19.0 MPa^{1/2}

X-22-174BX: 17.7 MPa^{1/2}

Vinylidene fluoride: 13.1 MPa^{1/2}

Styrene: 19.3 MPa^{1/2}

Acrylonitrile: 25.3 MPa^{1/2}

2-ethylhexyl acrylate: 18.7 MPa^{1/2}

Methacrylic acid (CH₂)₂(CF₂)₁₃(CF₃): 12.1 MPa^{1/2}

Methacrylate (CH₂)₂(CF₂)₇(CF₃): 13.1 MPa^{1/2}

1H,1H,2H,2H-pentafluorobutyl methacrylate: 15.9 MPa^{1/2}

Hexafluoropropene: 10.1 MPa^{1/2}

Tetrafluoroethylene: 10.1 MPa^{1/2}

Acrylic acid: 20.5 MPa^{1/2}

2-hydroxyethyl acrylate: 25.9 MPa^{1/2}

2. Synthesis of Sulfide-Based Inorganic Solid Electrolyte [Synthesis Example A]

A sulfide-based inorganic solid electrolyte was synthesized with reference to a non-patent document of T. Ohtomo, A. Hayashi, M. Tatsumisago, Y Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box in an argon atmosphere (dew point: −70° C.), lithium sulfide (Li₂S, manufactured by Sigma-Aldrich Co., LLC Co., LLC Co., LLC, purity: >99.98%) (2.42 g) and diphosphorus pentasulfide (P₂S₅, manufactured by Sigma-Aldrich Co., LLC Co., LLC Co., LLC, purity: >99%) (3.90 g) each were weighed, put into an agate mortar, and mixed using an agate pestle for five minutes. The mixing ratio between Li₂S and P₂S₅(Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 20 hours, thereby obtaining yellow powder (6.20 g) of a sulfide-based inorganic solid electrolyte (Li—P—S-based glass, hereinafter, may be referred to as LPS). The particle diameter of the Li—P—S-based glass was 15 μm.

### Example 1

Each composition shown in Table 2 was prepared as follows.

<Preparation of Inorganic Solid Electrolyte-Containing Compositions K-1, K-2, and KC-1 to KC-10>

60 g of zirconia beads having a diameter of 5 mm was put into a 45 mL container made of zirconia (manufactured by FRITSCH), and 8.4 g of the LPS synthesized in the above Synthesis Example A, 0.6 g (solid content mass) of the binder solution or the binder dispersion liquid shown in Table 2-1 and Table 2-3, and 11 g of butyl butyrate as the dispersion medium were put thereinto. Then, this container was set in a planetary ball mill P-7 (product name) manufactured by FRITSCH. Mixing was carried out at a temperature of 25° C. and a rotation speed of 150 rpm for 10 minutes to prepare each of inorganic solid electrolyte-containing compositions (slurries) K-1, K-2, and KC-1 to KC-10.

<Preparation of Positive Electrode Compositions PK-1 to PK-21>

60 g of zirconia beads having a diameter of 5 mm were put into a 45 mL container made of zirconia (manufactured by FRITSCH), and then 8 g of LPS synthesized in Synthesis Example A, and 13 g (total amount) of butyl butyrate as a dispersion medium were put into the above container. The container was set in a planetary ball mill P-7 (product name, manufactured by FRITSCH) and the components were stirred for 30 minutes at 25° C. and a rotation speed of 200 rpm. Then, into this container, 27.5 g of NMC (manufactured by Sigma-Aldrich Co., LLC) as the positive electrode active material, 1.0 g of acetylene black (AB) as the conductive auxiliary agent, and 0.5 g (solid content mass) of the binder solution shown in Table 2-1 were put. The container was set in a planetary ball mill P-7, and mixing was continued for 30 minutes at a temperature of 25° C. and a rotation speed of 200 rpm to prepare each of positive electrode compositions (slurries) PK-1 to PK-21.

<Preparation of Negative Electrode Compositions NK-1 to NK-21 and NKC-1 to NKC-10>

60 g of zirconia beads having a diameter of 5 mm was put into a 45 mL container made of zirconia (manufactured by FRITSCH), and 16.6 g of LPS synthesized in the above Synthesis Example A, 0.66 g (solid content mass) of the binder solution or binder dispersion liquid shown in Table 2-2 and Table 2-3, and 33.3 g (total amount) of the dispersion medium were put thereinto. The container was set in a planetary ball mill P-7 (product name, manufactured by FRITSCH) and the components were mixed for 60 minutes at a temperature of 25° C. and a rotation speed of 300 rpm. Then, 14.6 g of silicon (Si, manufactured by Sigma-Aldrich Co., LLC) as the negative electrode active material and 1.3 g of VGCF (manufactured by Showa Denko K.K.) as the conductive auxiliary agent were put into the container. Similarly, the container was subsequently set in a planetary ball mill P-7, and mixing was carried out at 25° C. for 10 minutes at a rotation speed of 100 rpm to prepare each of negative electrode compositions (slurries) NK-1 to NK-21 and NKC-1 to NKC-10.

Tables 2-1 to 2-3 (collectively referred to as Table 2) show polymers that form the polymer binders and SP values of the dispersion media. In addition, regarding each of the compositions, the difference (in terms of absolute value) between the SP value of the polymer that forms the polymer binder and the SP value of the dispersion medium was calculated and shown. The units of the SP value and the difference (in terms of absolute value) in SP value are MPa^{1/2}: however, the description thereof is omitted in Table 2.

In Table 2, the composition content is the content (% by mass) with respect to the total mass of the composition, and the solid content is the content (% by mass) with respect to 100% by mass of the solid content of the composition. The unit is omitted in the table.

TABLE 2

| | | Inorganic solid electrolyte | | | Binder solution or dispersion liquid | | | | Dispersion medium | | | Active material | | | Conductive auxiliary agent | | | | |
|---|---|---|---|---|---|---|---|---|---|---|---|---|---|---|---|---|---|---|---|
| | | | | Content | | | Content | | | Content | | | Content | | | | Content | | |
| | | | Composition | of solid | | Composition | of solid | SP | | of solid | SP | | of solid | SP | | Composition | of solid | Difference | |
| | No. | | content | content | | conent | content | value | | content | value | | content | value | | conent | content | in SP value | Note |
| Inorganic | K-1 | LPS | 42 | 93 | B-1 | 3 | 7 | 17.2 | Butyl butyrate | 55 | 18.6 | — | — | — | — | — | — | 1.4 | Present |
| solid | | | | | | | | | | | | | | | | | | | invention |
| electrolyte | K-2 | LPS | 42 | 93 | B-11 | 3 | 7 | 18.9 | Butyl butyrate | 55 | 18.6 | — | — | — | — | — | — | 0.3 | Present |
| composition | | | | | | | | | | | | | | | | | | | invention |
| Positive | PK-1 | LPS | 16 | 23 | B-1 | 1 | 1 | 17.2 | Butyl butyrate | 26 | 18.6 | NMC | 55 | 74 | AB | 2 | 3 | 1.4 | Present |
| electrode | | | | | | | | | | | | | | | | | | | invention |
| composition | PK-2 | LPS | 16 | 22 | B-2 | 1 | 1 | 17.4 | Butyl butyrate | 26 | 18.6 | NMC | 55 | 74 | AB | 2 | 3 | 1.2 | Present |
| | | | | | | | | | | | | | | | | | | | invention |
| | PK-3 | LPS | 16 | 22 | B-3 | 1 | 1 | 17.5 | Butyl butyrate | 26 | 18.6 | NMC | 55 | 74 | AB | 2 | 3 | 1.1 | Present |
| | | | | | | | | | | | | | | | | | | | invention |
| | PK-4 | LPS | 16 | 22 | B-4 | 1 | 1 | 17.7 | Butyl butyrate | 26 | 18.6 | NMC | 55 | 74 | AB | 2 | 3 | 0.9 | Present |
| | | | | | | | | | | | | | | | | | | | invention |
| | PK-5 | LPS | 16 | 22 | B-5 | 1 | 1 | 17.3 | Butyl butyrate | 26 | 18.6 | NMC | 55 | 74 | AB | 2 | 3 | 1.3 | Present |
| | | | | | | | | | | | | | | | | | | | invention |
| | PK-6 | LPS | 16 | 22 | B-6 | 1 | 1 | 18.4 | Butyl butyrate | 26 | 18.6 | NMC | 55 | 74 | AB | 2 | 3 | 0.2 | Present |
| | | | | | | | | | | | | | | | | | | | invention |
| | PK-7 | LPS | 16 | 22 | B-7 | 1 | 1 | 18.9 | Butyl butyrate | 26 | 18.6 | NMC | 55 | 74 | AB | 2 | 3 | 0.3 | Present |
| | | | | | | | | | | | | | | | | | | | invention |
| | PK-8 | LPS | 16 | 22 | B-8 | 1 | 1 | 18.8 | Butyl butyrate | 26 | 18.6 | NMC | 55 | 74 | AB | 2 | 3 | 0.2 | Present |
| | | | | | | | | | | | | | | | | | | | invention |
| | PK-9 | LPS | 16 | 22 | B-9 | 1 | 1 | 18.6 | Butyl butyrate | 26 | 18.6 | NMC | 55 | 74 | AB | 2 | 3 | 0.0 | Present |
| | | | | | | | | | | | | | | | | | | | invention |
| | PK-10 | LPS | 16 | 22 | B-10 | 1 | 1 | 19.2 | Butyl butyrate | 26 | 18.6 | NMC | 55 | 74 | AB | 2 | 3 | 0.6 | Present |
| | | | | | | | | | | | | | | | | | | | invention |
| | PK-11 | LPS | 16 | 22 | B-11 | 1 | 1 | 18.9 | Butyl butyrate | 26 | 18.6 | NMC | 55 | 74 | AB | 2 | 3 | 0.3 | Present |
| | | | | | | | | | | | | | | | | | | | invention |
| | PK-12 | LPS | 16 | 22 | B-12 | 1 | 1 | 19.2 | Butyl butyrate | 26 | 18.6 | NMC | 55 | 74 | AB | 2 | 3 | 0.6 | Present |
| | | | | | | | | | | | | | | | | | | | invention |
| | PK-13 | LPS | 16 | 22 | B-13 | 1 | 1 | 19.2 | Butyl butyrate | 26 | 18.6 | NMC | 55 | 74 | AB | 2 | 3 | 0.6 | Present |
| | | | | | | | | | | | | | | | | | | | invention |
| | PK-14 | LPS | 16 | 22 | B-14 | 1 | 1 | 17.2 | Butyl butyrate | 26 | 18.6 | NMC | 55 | 74 | AB | 2 | 3 | 1.4 | Present |
| | | | | | | | | | | | | | | | | | | | invention |
| | PK-15 | LPS | 16 | 22 | B-15 | 1 | 1 | 18.9 | Butyl butyrate | 26 | 18.6 | NMC | 55 | 74 | AB | 2 | 3 | 0.3 | Present |
| | | | | | | | | | | | | | | | | | | | invention |
| | PK-16 | LPS | 16 | 22 | B-16 | 1 | 1 | 16.4 | Butyl butyrate | 26 | 18.6 | NMC | 55 | 74 | AB | 2 | 3 | 2.2 | Present |
| | | | | | | | | | | | | | | | | | | | invention |
| | PK-17 | LPS | 16 | 22 | B-17 | 1 | 1 | 16.2 | Butyl butyrate | 26 | 18.6 | NMC | 55 | 74 | AB | 2 | 3 | 2.4 | Present |
| | | | | | | | | | | | | | | | | | | | invention |
| | PK-18 | LPS | 16 | 22 | B-18 | 1 | 1 | 19.0 | Butyl butyrate | 26 | 18.6 | NMC | 55 | 74 | AB | 2 | 3 | 0.4 | Present |
| | | | | | | | | | | | | | | | | | | | invention |
| | PK-19 | LPS | 16 | 22 | B-19 | 1 | 1 | 18.5 | Butyl butyrate | 26 | 18.6 | NMC | 55 | 74 | AB | 2 | 3 | 0.1 | Present |
| | | | | | | | | | | | | | | | | | | | invention |
| | PK-20 | LPS | 16 | 22 | B-1 | 1 | 1 | 17.2 | Perfluorotuene | 26 | 13.4 | NMC | 55 | 74 | AB | 2 | 3 | 3.8 | Present |
| | | | | | | | | | | | | | | | | | | | invention |
| | PK-21 | LPS | 16 | 22 | B-11 | 1 | 1 | 18.9 | Perfluorotuene | 26 | 13.4 | NMC | 55 | 74 | AB | 2 | 3 | 5.5 | Present |
| | | | | | | | | | | | | | | | | | | | invention |
| Negative | NK-1 | LPS | 25 | 50 | B-1 | 1 | 2 | 17.2 | Butyl butyrate | 50 | 18.6 | Si | 22 | 44 | VGCF | 2 | 4 | 1.4 | Present |
| electrode | | | | | | | | | | | | | | | | | | | invention |
| composition | NK-2 | LPS | 25 | 50 | B-2 | 1 | 2 | 17.4 | Butyl butyrate | 50 | 18.6 | Si | 22 | 44 | VGCF | 2 | 4 | 1.2 | Present |
| | | | | | | | | | | | | | | | | | | | invention |
| | NK-3 | LPS | 25 | 50 | B-3 | 1 | 2 | 17.5 | Butyl butyrate | 50 | 18.6 | Si | 22 | 44 | VGCF | 2 | 4 | 1.1 | Present |
| | | | | | | | | | | | | | | | | | | | invention |
| | NK-4 | LPS | 25 | 50 | B-4 | 1 | 2 | 17.7 | Butyl butyrate | 50 | 18.6 | Si | 22 | 44 | VGCF | 2 | 4 | 0.9 | Present |
| | | | | | | | | | | | | | | | | | | | invention |
| | NK-5 | LPS | 25 | 50 | B-5 | 1 | 2 | 17.3 | Butyl butyrate | 50 | 18.6 | Si | 22 | 44 | VGCF | 2 | 4 | 1.3 | Present |
| | | | | | | | | | | | | | | | | | | | invention |
| | NK-6 | LPS | 25 | 50 | B-6 | 1 | 2 | 18.4 | Butyl butyrate | 50 | 18.6 | Si | 22 | 44 | VGCF | 2 | 4 | 0.2 | Present |
| | | | | | | | | | | | | | | | | | | | invention |
| | NK-7 | LPS | 25 | 50 | B-7 | 1 | 7 | 18.9 | Butyl butyrate | 50 | 18.6 | Si | 22 | 44 | VGCF | 2 | 4 | 0.3 | Present |
| | | | | | | | | | | | | | | | | | | | invention |
| | NK-8 | LPS | 25 | 50 | B-8 | 1 | 2 | 18.8 | Butyl butyrate | 50 | 18.6 | Si | 22 | 44 | VGCF | 2 | 4 | 0.2 | Present |
| | | | | | | | | | | | | | | | | | | | invention |
| | NK-9 | LPS | 25 | 50 | B-9 | 1 | 2 | 18.6 | Butyl butyrate | 50 | 18.6 | Si | 22 | 44 | VGCF | 2 | 4 | 0.0 | Present |
| | | | | | | | | | | | | | | | | | | | invention |
| | NK-10 | LPS | 25 | 50 | B-10 | 1 | 2 | 919.2 | Butyl butyrate | 50 | 18.6 | Si | 22 | 44 | VGCF | 2 | 4 | 0.6 | Present |
| | | | | | | | | | | | | | | | | | | | invention |
| | NK-11 | LPS | 25 | 50 | B-11 | 1 | 2 | 18.9 | Butyl butyrate | 50 | 18.6 | Si | 22 | 44 | VGCF | 2 | 4 | 0.3 | Present |
| | | | | | | | | | | | | | | | | | | | invention |
| | NK-12 | LPS | 25 | 50 | B-12 | 1 | 2 | 19.2 | Butyl butyrate | 50 | 18.6 | Si | 22 | 44 | VGCF | 2 | 4 | 0.6 | Present |
| | | | | | | | | | | | | | | | | | | | invention |
| | NK-13 | LPS | 25 | 50 | B-13 | 1 | 2 | 19.2 | Butyl butyrate | 50 | 18.6 | Si | 22 | 44 | VGCF | 2 | 4 | 0.6 | Present |
| | | | | | | | | | | | | | | | | | | | invention |
| | NK-14 | LPS | 25 | 50 | B-14 | 1 | 2 | 17.2 | Butyl butyrate | 50 | 18.6 | Si | 22 | 44 | VGCF | 2 | 4 | 1.4 | Present |
| | | | | | | | | | | | | | | | | | | | invention |
| | NK-15 | LPS | 25 | 20 | B-15 | 1 | 2 | 18.9 | Butyl butyrate | 50 | 18.6 | Si | 22 | 44 | VGCF | 2 | 4 | 0.3 | Present |
| | | | | | | | | | | | | | | | | | | | invention |
| | NK-16 | LPS | 22 | 50 | B-16 | 1 | 2 | 16.4 | Butyl butyrate | 50 | 18.6 | Si | 22 | 44 | VGCF | 2 | 4 | 2.2 | Present |
| | | | | | | | | | | | | | | | | | | | invention |
| | NK-17 | LPS | 25 | 50 | B-17 | 1 | 2 | 18.2 | Butyl butyrate | 50 | 18.6 | Si | 22 | 44 | VGCF | 2 | 4 | 2.4 | Present |
| | | | | | | | | | | | | | | | | | | | invention |
| | NK-18 | LPS | 25 | 50 | B-15 | 1 | 2 | 19.0 | Butyl butyrate | 50 | 18.6 | Si | 22 | 44 | VGCF | 2 | 4 | 0.4 | Present |
| | | | | | | | | | | | | | | | | | | | invention |
| | NK-19 | LPS | 25 | 50 | B-19 | 1 | 2 | 18.5 | Butyl butyrate | 50 | 18.6 | Si | 22 | 44 | VGCF | 2 | 4 | 0.1 | Present |
| | | | | | | | | | | | | | | | | | | | invention |
| | PK-20 | LPS | 25 | 50 | B-1 | 1 | 2 | 17.2 | Perfluorotuene | 50 | 13.4 | Si | 22 | 44 | VGCF | 2 | 4 | 3.8 | Present |
| | | | | | | | | | | | | | | | | | | | invention |
| | PK-21 | LPS | 25 | 50 | B-11 | 1 | 2 | 15.9 | Perfluorotuene | 50 | 13.4 | Si | 22 | 44 | VGCF | 2 | 4 | 5.5 | Present |
| | | | | | | | | | | | | | | | | | | | invention |
| Inorganic | KC-1 | LPS | 42 | 93 | T-1 | 3 | 7 | 18.8 | Butyl butyrate | 55 | 18.6 | — | — | — | — | — | — | 0.2 | Comp- |
| solid | | | | | | | | | | | | | | | | | | | arative |
| electrolyte | | | | | | | | | | | | | | | | | | | Example |
| composition | KC-2 | LPS | 42 | 93 | T-2 | 3 | 7 | 13.1 | Butyl butyrate | 55 | 18.6 | — | — | — | — | — | — | 5.5 | Comp- |
| | | | | | | | | | | | | | | | | | | | arative |
| | | | | | | | | | | | | | | | | | | | Example |
| | KC-3 | LPS | 42 | 93 | T-3 | 3 | 7 | 12.6 | Butyl butyrate | 55 | 18.6 | — | — | — | — | — | — | 6.0 | Comp- |
| | | | | | | | | | | | | | | | | | | | arative |
| | | | | | | | | | | | | | | | | | | | Example |
| | KC-4 | LPS | 42 | 93 | T-4 | 3 | 7 | 11.4 | Butyl butyrate | 55 | 18.6 | — | — | — | — | — | — | 7.2 | Comp- |
| | | | | | | | | | | | | | | | | | | | arative |
| | | | | | | | | | | | | | | | | | | | Example |
| | KC-5 | LPS | 42 | 93 | T-5 | 3 | 7 | 20.3 | Butyl butyrate | 55 | 18.6 | — | — | — | — | — | — | 1.7 | Comp- |
| | | | | | | | | | | | | | | | | | | | arative |
| | | | | | | | | | | | | | | | | | | | Example |
| | KC-6 | LPS | 42 | 93 | T-6 | 3 | 7 | 23.2 | Butyl butyrate | 55 | 18.6 | — | — | — | — | — | — | 4.6 | Comp- |
| | | | | | | | | | | | | | | | | | | | arative |
| | | | | | | | | | | | | | | | | | | | Example |
| | KC-7 | LPS | 42 | 93 | T-7 | 3 | 7 | 21.8 | Butyl butyrate | 55 | 18.6 | — | — | — | — | — | — | 3.2 | Comp- |
| | | | | | | | | | | | | | | | | | | | arative |
| | | | | | | | | | | | | | | | | | | | Example |
| | KC-8 | LPS | 42 | 93 | T-8 | 3 | 7 | 13.6 | Butyl butyrate | 55 | 18.6 | — | — | — | — | — | — | 5.0 | Comp- |
| | | | | | | | | | | | | | | | | | | | arative |
| | | | | | | | | | | | | | | | | | | | Example |
| | KC-9 | LPS | 42 | 93 | T-9 | 3 | 7 | 23.5 | Butyl butyrate | 55 | 18.6 | — | — | — | — | — | — | 4.9 | Comp- |
| | | | | | | | | | | | | | | | | | | | arative |
| | | | | | | | | | | | | | | | | | | | Example |
| | KC-10 | LPS | 42 | 93 | T-10 | 3 | 7 | 19.9 | Butyl butyrate | 55 | 18.6 | — | — | — | — | — | — | 1.3 | Comp- |
| | | | | | | | | | | | | | | | | | | | arative |
| | | | | | | | | | | | | | | | | | | | Example |
| Negative | NKC-1 | LPS | 25 | 50 | T-1 | 1 | 2 | 18.8 | Butyl butyrate | 50 | 18.6 | Si | 22 | 44 | VGCF | 2 | 4 | 0.2 | Comp- |
| electrode | | | | | | | | | | | | | | | | | | | arative |
| composition | | | | | | | | | | | | | | | | | | | Example |
| | NKC-2 | LPS | 25 | 50 | T-2 | 1 | 2 | 13.1 | Butyl butyrate | 50 | 18.6 | Si | 22 | 44 | VGCF | 2 | 4 | 5.5 | Comp- |
| | | | | | | | | | | | | | | | | | | | arative |
| | | | | | | | | | | | | | | | | | | | Example |
| | NKC-3 | LPS | 25 | 50 | T-3 | 1 | 2 | 12.6 | Butyl butyrate | 50 | 18.6 | Si | 22 | 44 | VGCF | 2 | 4 | 6.0 | Comp- |
| | | | | | | | | | | | | | | | | | | | arative |
| | | | | | | | | | | | | | | | | | | | Example |
| | NKC-4 | LPS | 25 | 50 | T-4 | 1 | 2 | 11.4 | Butyl butyrate | 50 | 18.6 | Si | 22 | 44 | VGCF | 2 | 4 | 7.2 | Comp- |
| | | | | | | | | | | | | | | | | | | | arative |
| | | | | | | | | | | | | | | | | | | | Example |
| | NKC-5 | LPS | 25 | 50 | T-5 | 1 | 2 | 20.3 | Butyl butyrate | 50 | 18.6 | Si | 22 | 44 | VGCF | 2 | 4 | 1.7 | Comp- |
| | | | | | | | | | | | | | | | | | | | arative |
| | | | | | | | | | | | | | | | | | | | Example |
| | NKC-6 | LPS | 25 | 50 | T-6 | 1 | 2 | 23.2 | Butyl butyrate | 50 | 18.6 | Si | 22 | 44 | VGCF | 2 | 4 | 4.6 | Comp- |
| | | | | | | | | | | | | | | | | | | | arative |
| | | | | | | | | | | | | | | | | | | | Example |
| | NKC-7 | LPS | 25 | 50 | T-7 | 1 | 2 | 21.8 | Butyl butyrate | 50 | 18.6 | Si | 22 | 44 | VGCF | 2 | 4 | 3.2 | Comp- |
| | | | | | | | | | | | | | | | | | | | arative |
| | | | | | | | | | | | | | | | | | | | Example |
| | NKC-8 | LPS | 25 | 59 | T-8 | 1 | 2 | 13.6 | Butyl butyrate | 50 | 18.6 | Si | 22 | 43 | VGCF | 3 | 6 | 5.0 | Comp- |
| | | | | | | | | | | | | | | | | | | | arative |
| | | | | | | | | | | | | | | | | | | | Example |
| | NKC-9 | LPS | 25 | 50 | T--9 | 1 | 2 | 23.5 | Butyl butyrate | 50 | 18.6 | Si | 22 | 44 | VGCF | 2 | 4 | 4.9 | Comp- |
| | | | | | | | | | | | | | | | | | | | arative |
| | | | | | | | | | | | | | | | | | | | Example |
| | NKC-10 | LPS | 25 | 50 | T-10 | 1 | 2 | 19.9 | Butyl butyrate | 50 | 18.6 | Si | 22 | 44 | VGCF | 2 | 4 | 1.3 | Comp- |
| | | | | | | | | | | | | | | | | | | | arative |
| | | | | | | | | | | | | | | | | | | | Example |

### Abbreviations in Table

LPS: LPS synthesized in Synthesis Example A

NMC: LiNi_{1/3}Co_{1/3}Mn_{1/3}O₂

Si: Silicon

AB: Acetylene black

VGCF: Carbon nanotube (manufactured by Showa Denko K.K.)

<Production of Solid Electrolyte Sheets 101, 102, and c11 to c20 for all-Solid State Secondary Battery>

Each of the inorganic solid electrolyte-containing compositions shown in the column of “Solid electrolyte composition No.” of Table 3-1 and Table 3-3 obtained as described above was applied onto an aluminum foil having a thickness of 20 μm using a baker type applicator (product name: SA-201, manufactured by Tester Sangyo Co., Ltd.) and heated at 80° C. for 2 hours to dry (to remove the dispersion medium) the inorganic solid electrolyte-containing composition. Then, using a heat press machine, the inorganic solid electrolyte-containing composition dried at a temperature of 120° C. and a pressure of 40 MPa for 10 seconds was heated and pressurized to produce each of solid electrolyte sheets 101, 102, and c11 to c20 for an all-solid state secondary battery (in Table 3, it is written as “Solid electrolyte sheet”). The film thickness of the solid electrolyte layer was 50 m.

<Production of Positive Electrode Sheets 103 to 123 for all-Solid State Secondary Battery>

Each of the positive electrode compositions obtained as described above, which is shown in the column of “Electrode composition No.” in Table 3-1, was applied onto an aluminum foil having a thickness of 20 μm by using a baker type applicator (product name: SA-201), heating was carried out at 80° C. for 1 hour, and then heating was further carried out at 110° C. for 1 hour to dry (to remove the dispersion medium) the positive electrode composition. Then, using a heat press machine, the dried positive electrode composition was pressurized (10 MPa, 1 minute) at 25° C. to produce each of positive electrode sheets 103 to 123 for an all-solid state secondary battery, having a positive electrode active material layer having a film thickness of 80 μm (in Table 3, it is written as “Positive electrode sheet”).

<Production of Negative Electrode Sheets 124 to 144 and c21 to c30 for all-Solid State Secondary Battery>

Each of the compositions for a negative electrode obtained as described above, which is shown in the column of “Electrode composition No.” of Table 3-2 and Table 3-3, was applied onto a copper foil having a thickness of 20 μm by using a baker type applicator (product name: SA-201), heating was carried out at 80° C. for 1 hour, and then heating was further carried out at 110° C. for 1 hour to dry (to remove the dispersion medium) the negative electrode composition. Then, using a heat press machine, the dried negative electrode composition was pressurized (10 MPa, 1 minute) at 25° C. to produce each of negative electrode sheets 124 to 144 and c21 to c30 for an all-solid state secondary battery, having a negative electrode active material layer having a film thickness of 70 μm (in Table 3, it is written as “Negative electrode sheet”).

The following evaluations were carried out for each of the manufactured compositions and each of the sheets, and the results are shown in Table 3-1 to Table 3-3 (collectively referred to as Table 3).

<Evaluation 1: Dispersibility>

The viscosity of each composition prepared as described above was measured, and the dispersibility was evaluated by determining where the obtained viscosity was included in any of the following evaluation standards.

In this test, it is indicated that the lower the viscosity is, the more excellent the dispersibility is, and the evaluation standard “D” or higher is the pass level.

—Measuring Method for Viscosity—

Using an E-type viscometer (TV-35 type, manufactured by TOKI SANGYO Co., Ltd.) and a standard cone rotor (1° 34′×R24), 1.1 mL of a sample (a composition) was applied to a sample cup adjusted to a predetermined measurement temperature, set in the main body, and maintained for 5 minutes until the temperature became constant. Then, the measurement range was set to “U”, and a value obtained by measuring at a shear rate of 10/s (rotation speed: 2.5 rpm) one minute after the start of rotation was defined as the viscosity.

—Evaluation Standards—

A: Less than 300 cP

B: 300 cP or more and less than 500 cP

C: 500 cP or more and less than 800 cP

D: 800 cP or more and less than 1500 cP

E: 1,500 cP or more

<Evaluation 2: Interface Resistance>

(1) Preparation of Test Specimen for Measuring Ion Conductivity

The obtained solid electrolyte sheet or the obtained electrode sheets (the positive electrode sheet for an all-solid state secondary battery and the negative electrode sheet for an all-solid state secondary battery) were cut into a disk shape having a diameter of 14.5 mm, and the solid electrolyte sheet or the electrode sheets were placed in a 2032-type coin case 11 illustrated in FIG. 2. Specifically, an aluminum foil (not illustrated in FIG. 2) cut into a disk shape having a diameter of 15 mm was brought into contact with a solid electrolyte layer or an electrode active material layer, and a spacer and a washer (both not illustrated in FIG. 2) were placed in the 2032-type coin case 11 made of stainless steel. The 2032-type coin case 11 was crimped to prepare a test specimen for measuring ion conductivity, which was fastened with a force of 8 Newton (N).

(2) Measurement of Ion Conductivity of Test Specimen for Measuring Ion Conductivity

Regarding each test specimen for measuring ion conductivity prepared above, the ion conductivity at 0° C. was measured to evaluate the interface resistance under the low temperature condition. Specifically, the alternating-current impedance of each test specimen for measuring ion conductivity was measured in a constant-temperature tank (0° C.) using a 1255B FREQUENCY RESPONSE ANALYZER (product name, manufactured by SOLARTRON Analytical) at a voltage magnitude of 5 mV and a frequency of 1 MHz to 1 Hz. From the measurement result, the resistance of the sample for measuring ion conductivity in the layer thickness direction was determined, and the ion conductivity under the low temperature condition was determined by the calculation according to Expression (1).

Ion conductivity σ (mS/cm)=1,000×sample layer thickness (cm)/[resistance (Ω)×sample area (cm²)] Expression (1):

In Expression (1), the sample layer thickness is a value obtained by measuring the thickness before placing the solid electrolyte sheet or the electrode active material layer in the 2032-type coin case 11 and subtracting the thickness of the collector (the total layer thickness of the solid electrolyte layer and the electrode active material layer). The sample area is the area of the disk-shaped sheet having a diameter of 14.5 mm.

It was determined where the obtained ion conductivity a was included in any of the following evaluation standards.

In this test, in a case where the evaluation standard is “D” or higher, the ion conductivity σ is the pass level.

—Evaluation Standards—

In case of solid electrolyte sheet

A: 1.6≤σ

B: 1.4≤σ<1.6

C: 1.2≤σ<1.4

D: 1.0≤σ<1.2

E: σ<1.0 in case of electrode sheet

A: 0.8≤σ

B: 0.7≤σ<0.8

C: 0.6≤σ<0.7

D: 0.5≤σ<0.6

E: σ<0.5

<Evaluation 3: Suppression of SE Deterioration>

Using sheets of each of the produced solid electrolyte sheet and the electrode sheet, which were respectively those before and after being left in the air (25° C., relative humidity 50%) for 1 hour (exposure to the air) the ion conductivity was measured for a set of all-solid state secondary batteries manufactured in the same manner as in [Manufacture of all-solid state secondary battery] described later. The reduction rate (%) of the ion conductivity of the all-solid state secondary battery into which the sheet before being left to stand was incorporated and the all-solid state secondary battery into which the sheet after being left to stand was incorporated was calculated, and the effect of suppressing the deterioration of the solid electrolyte (SE) was evaluated by determining where the obtained reduction rate was included in any of the following evaluation standards. The ion conductivity was measured in the same manner as in “(2) Measurement of ion conductivity of test specimen for measuring ion conductivity” in <Evaluation 2: Interface resistance> described above, except that the measurement temperature was changed to 25° C.

In this test, it is indicated that the smaller the reduction rate (%) of the ion conductivity is, the more the deterioration of the inorganic solid electrolyte due to moisture can be suppressed, and the evaluation standard “D” or higher is the pass level.

Reduction rate of ion conductivity (%)=[(ion conductivity of all-solid state secondary battery into which sheet before being left to stand is incorporated−ion conductivity of all-solid state secondary battery into which sheet after being left to stand is incorporated)/ion conductivity before being left to stand]×100

—Evaluation Standards—

A: 90% or more

B: 80% or more and less than 90%

C: 70% or more and less than 80%

D: 60% or more and less than 70%

E: less than 60%

<Evaluation 4: Adhesiveness>

As a reference test, the adhesiveness between the collector and the active material layer in the positive electrode sheet for an all-solid state secondary battery and the negative electrode sheet for an all-solid state secondary battery was evaluated.

Specifically, a test piece having a length of 20 mm and a width of 20 mm was cut out from each of the prepared positive electrode sheets for all-solid state secondary battery and each of the negative electrode sheets for an all-solid state secondary battery. 11 cuts were made in the test piece using a utility knife so that the cuts reached the substrate (the aluminum foil or the copper foil) at 1 mm intervals parallel to one side. In addition, 11 cuts were made so that the cuts reached the substrate at 1 mm intervals in the direction perpendicular to the cuts. In this manner, 100 squares were formed on the test piece.

A Cellophane tape (registered trade name) having a length of 15 mm and a width of 18 mm was attached to the surface of the active material layer to cover all the 100 squares. The surface of the Cellophane tape (registered trade name) was rubbed with an eraser and pressed against the active material layer to be adhered thereto. Two minutes after the Cellophane tape (registered trade name) was attached, the end of the Cellophane tape (registered trade name) was held and pulled upward vertically with respect to the active material layer, to be peeled off. After peeling off the Cellophane tape (registered trade name), the surface of the active material layer was visually observed, the number of squares where no peeling from the collector had occurred was counted, and the adhesiveness of the active material layer to the collector was evaluated by determining where the obtained number of squares was included in any of the following evaluation standards.

In this test, it is indicated that the more the squares where no peeling from the collector occurred, the more firm the adhesiveness to the collector, and the evaluation standard “D” or higher is the pass level.

—Evaluation Standards—

A: 80 squares or more

B: 60 squares or more and less than 80 squares

C: 40 squares or more and less than 60 squares

D: 30 squares or more and less than 40 squares

E: Less than 30 squares

TABLE 3

| | Solid | | | | | | | | | |
|---|---|---|---|---|---|---|---|---|---|---|
| | electrolyte | | Electrode | | | | | Suppression | | |
| Sheet | composition | Polymer | composition | Polymer | | Interface | Adhesive- | of SE | | |
| No. | no. | No. | No. | No. | Dispersibility | resistance | ness | deterioration | Note 1 | Note 2 |
| 101 | K-1 | B-1 | — | — | C | C | — | C | Solid | Present |
| | | | | | | | | | electrolyte | invention |
| 102 | K-2 | B-11 | — | — | A | A | — | A | sheet | Present |
| | | | | | | | | | | invention |
| 103 | — | — | PK-1 | B-1 | C | C | C | C | Positive | Present |
| | | | | | | | | | electrode | invention |
| 104 | — | — | PK-2 | B-2 | C | C | C | C | sheet | Present |
| | | | | | | | | | | invention |
| 105 | — | — | PK-3 | B-3 | C | C | C | C | | Present |
| | | | | | | | | | | invention |
| 106 | — | — | PK-4 | B-4 | D | C | C | C | | Present |
| | | | | | | | | | | invention |
| 107 | — | — | PK-5 | B-5 | D | C | C | C | | Present |
| | | | | | | | | | | invention |
| 108 | — | — | PK-6 | B-6 | C | C | C | C | | Present |
| | | | | | | | | | | invention |
| 109 | — | — | PK-7 | B-7 | C | C | C | C | | Present |
| | | | | | | | | | | invention |
| 110 | — | — | PK-8 | B-8 | C | C | B | C | | Present |
| | | | | | | | | | | invention |
| 111 | — | — | PK-9 | B-9 | B | B | B | B | | Present |
| | | | | | | | | | | invention |
| 112 | — | — | PK-10 | B-10 | B | B | B | B | | Present |
| | | | | | | | | | | invention |
| 113 | — | — | PK-11 | B-11 | A | A | A | A | | Present |
| | | | | | | | | | | invention |
| 114 | — | — | PK-12 | B-12 | A | A | A | A | | Present |
| | | | | | | | | | | invention |
| 115 | — | — | PK-13 | B-13 | B | B | B | B | | Present |
| | | | | | | | | | | invention |
| 116 | — | — | PK-14 | B-14 | B | B | C | B | | Present |
| | | | | | | | | | | invention |
| 117 | — | — | PK-15 | B-15 | B | B | B | B | | Present |
| | | | | | | | | | | invention |
| 118 | — | — | PK-16 | B-16 | C | C | C | C | | Present |
| | | | | | | | | | | invention |
| 119 | — | — | PK-17 | B-17 | C | C | C | C | | Present |
| | | | | | | | | | | invention |
| 120 | — | — | PK-18 | B-18 | C | C | C | C | | Present |
| | | | | | | | | | | invention |
| 121 | — | — | PK-19 | B-19 | C | C | C | C | | Present |
| | | | | | | | | | | invention |
| 122 | — | — | PK-20 | B-1 | D | D | D | D | | Present |
| | | | | | | | | | | invention |
| 123 | — | — | PK-21 | B-11 | C | B | B | B | | Present |
| | | | | | | | | | | invention |
| | | | | | | | | Suppression | | |
| Sheet | Electrode | | Polymer | | | Interface | Adhesive- | of SE | | |
| No. | composition No. | | No. | Dispersibility | | resistance | ness | deterioration | Note 1 | Note 2 |
| 124 | NK-1 | | B-1 | C | | C | C | C | Negative | Present |
| | | | | | | | | | electrode | invention |
| 125 | NK-2 | | B-2 | C | | C | C | C | sheet | Present |
| | | | | | | | | | | invention |
| 126 | NK-3 | | B-3 | C | | C | C | C | | Present |
| | | | | | | | | | | invention |
| 127 | NK-4 | | B-4 | D | | C | C | C | | Present |
| | | | | | | | | | | invention |
| 128 | NK-5 | | B-5 | D | | C | C | C | | Present |
| | | | | | | | | | | invention |
| 129 | NK-6 | | B-6 | C | | C | C | C | | Present |
| | | | | | | | | | | invention |
| 130 | NK-7 | | B-7 | C | | C | C | C | | Present |
| | | | | | | | | | | invention |
| 131 | NK-8 | | B-8 | C | | C | B | C | | Present |
| | | | | | | | | | | invention |
| 132 | NK-9 | | B-9 | B | | B | B | B | | Present |
| | | | | | | | | | | invention |
| 133 | NK-10 | | B-10 | B | | B | B | B | | Present |
| | | | | | | | | | | invention |
| 134 | NK-11 | | B-11 | A | | A | A | A | | Present |
| | | | | | | | | | | invention |
| 135 | NK-12 | | B-12 | A | | A | A | A | | Present |
| | | | | | | | | | | invention |
| 136 | NK-13 | | B-13 | B | | B | B | B | | Present |
| | | | | | | | | | | invention |
| 137 | NK-14 | | B-14 | B | | B | C | B | | Present |
| | | | | | | | | | | invention |
| 138 | NK-15 | | B-15 | B | | B | B | B | | Present |
| | | | | | | | | | | invention |
| 139 | NK-16 | | B-16 | C | | C | C | C | | Present |
| | | | | | | | | | | invention |
| 140 | NK-17 | | B-17 | C | | C | C | C | | Present |
| | | | | | | | | | | invention |
| 141 | NK-18 | | B-18 | C | | C | C | C | | Present |
| | | | | | | | | | | invention |
| 142 | NK-19 | | B-19 | C | | C | C | C | | Present |
| | | | | | | | | | | invention |
| 143 | NK-20 | | B-1 | D | | D | D | D | | Present |
| | | | | | | | | | | invention |
| 144 | NK-21 | | B-11 | C | | B | B | B | | Present |
| | | | | | | | | | | invention |
| | Solid | | | | | | | | | |
| | electrolyte | | Electrode | | | | | Suppression | | |
| Sheet | composition | Polymer | composition | Polymer | | Interface | Adhesive- | of SE | | |
| No. | no. | No. | No. | No. | Dispersibility | resistance | ness | deterioration | Note 1 | Note 2 |
| c11 | KC-1 | T-1 | — | — | C | E | — | E | Solid | Com- |
| | | | | | | | | | electrolyte | parative |
| | | | | | | | | | sheet | Example |
| c12 | KC-2 | T-2 | — | — | E | D | — | D | | Com- |
| | | | | | | | | | | parative |
| | | | | | | | | | | Example |
| c13 | KC-3 | T-3 | — | — | E | D | — | D | | Com- |
| | | | | | | | | | | parative |
| | | | | | | | | | | Example |
| c14 | KC-4 | T-4 | — | — | E | D | — | D | | Com- |
| | | | | | | | | | | parative |
| | | | | | | | | | | Example |
| c15 | KC-5 | T-5 | — | — | E | E | — | E | | Com- |
| | | | | | | | | | | parative |
| | | | | | | | | | | Example |
| c16 | KC-6 | T-6 | — | — | E | E | — | E | | Com- |
| | | | | | | | | | | parative |
| | | | | | | | | | | Example |
| c17 | KC-7 | T-7 | — | — | E | D | — | D | | Com- |
| | | | | | | | | | | parative |
| | | | | | | | | | | Example |
| c18 | KC-8 | T-8 | — | — | E | D | — | D | | Com- |
| | | | | | | | | | | parative |
| | | | | | | | | | | Example |
| c19 | KC-9 | T-9 | — | — | E | D | — | D | | Com- |
| | | | | | | | | | | parative |
| | | | | | | | | | | Example |
| c20 | KC-10 | T-10 | — | — | E | D | — | D | | Com- |
| | | | | | | | | | | parative |
| | | | | | | | | | | Example |
| c21 | — | — | NKC-1 | T-1 | C | E | E | E | Negative | Com- |
| | | | | | | | | | electrode | parative |
| | | | | | | | | | sheet | Example |
| c22 | — | — | NKC-2 | T-2 | E | D | D | D | | Com- |
| | | | | | | | | | | parative |
| | | | | | | | | | | Example |
| c23 | — | — | NKC-3 | T-3 | E | D | D | D | | Com- |
| | | | | | | | | | | parative |
| | | | | | | | | | | Example |
| c24 | — | — | NKC-4 | T-4 | E | D | D | D | | Com- |
| | | | | | | | | | | parative |
| | | | | | | | | | | Example |
| c25 | — | — | NKC-5 | T-5 | E | E | E | E | | Com- |
| | | | | | | | | | | parative |
| | | | | | | | | | | Example |
| c26 | — | — | NKC-6 | T-6 | E | E | E | E | | Com- |
| | | | | | | | | | | parative |
| | | | | | | | | | | Example |
| c27 | — | — | NKC-7 | T-7 | E | D | E | D | | Com- |
| | | | | | | | | | | parative |
| | | | | | | | | | | Example |
| c28 | — | — | NKC-8 | T-8 | E | D | E | D | | Com- |
| | | | | | | | | | | parative |
| | | | | | | | | | | Example |
| c29 | — | — | NKC-9 | T-9 | E | E | E | E | | Com- |
| | | | | | | | | | | parative |
| | | | | | | | | | | Example |
| c30 | — | — | NKC-10 | T-10 | E | D | E | D | | Com- |
| | | | | | | | | | | parative |
| | | | | | | | | | | Example |

[Manufacture of all-Solid State Secondary Battery]

Using the produced solid electrolyte sheet and electrode sheet, an all-solid state secondary battery having the layer configuration illustrated in FIG. 1 was manufactured as follows.

<Production of Positive Electrode Sheets 103 to 123 for all-Solid State Secondary Battery, which Include Solid Electrolyte Layer>

The solid electrolyte sheet c11 for an all-solid state secondary battery, produced as described above, was overlaid on the positive electrode active material layer of each of the positive electrode sheets for an all-solid state secondary battery shown in the column of “Electrode active material layer (sheet No.)” of Table 4-1 so that the solid electrolyte layer came into contact with the positive electrode active material layer, transferred (laminated) by being pressurized at 50 MPa and 25° C. using a press machine, and then further pressurized at 600 MPa and at 25° C., whereby each of positive electrode sheets 103 to 123 for an all-solid state secondary battery having a thickness of 30 m (thickness of positive electrode active material layer: 60 μm) was produced.

<Production of Negative Electrode Sheets 124 to 144 and c21 to c30 for all-Solid State Secondary Battery, which Include Solid Electrolyte Layer>

The solid electrolyte sheet for an all-solid state secondary battery shown in the column of “Solid electrolyte layer (Sheet No.)” of Table 4-2, prepared as described above, was overlaid on the negative electrode active material layer of each of the negative electrode sheets for an all-solid state secondary battery shown in the column of “Electrode active material layer (Sheet No.)” of Table 4-2 so that it came into contact with the negative electrode active material layer, transferred (laminated) by being pressurized at 50 MPa and 25° C. using a press machine, and then pressurized at 600 MPa and at 25° C., whereby each of negative electrode sheets 124 to 144 and c21 to c30 for an all-solid state secondary battery having a thickness of 30 m (thickness of negative electrode active material layer: 50 μm) was produced.

<Manufacturing of all-Solid State Secondary Battery>

An all-solid state secondary battery No. 101 having a layer configuration illustrated in FIG. 1 was manufactured as follows.

(Production of Negative Electrode Sheet No. c21 for all-Solid State Secondary Battery, which Includes Solid Electrolyte Layer)

First, a negative electrode sheet No. c21 for an all-solid state secondary battery, which would be used in the manufacture of the all-solid state secondary battery No. 101, was produced.

The solid electrolyte sheet No. 101 for an all-solid state secondary battery shown in the column of “Solid electrolyte layer (Sheet No.)” of Table 4-1, prepared as described above, was overlaid on the negative electrode active material layer of the negative electrode sheet No. c21 for an all-solid state secondary battery shown in the column of “Electrode active material layer (Sheet No.)” of Table 4-1 so that it came into contact with the negative electrode active material layer, transferred (laminated) by being pressurized at 50 MPa and 25° C. using a press machine, and then pressurized at 600 MPa and at 25° C., whereby each of negative electrode sheet No. c21 for an all-solid state secondary battery having a thickness of 30 μm (thickness of negative electrode active material layer: 50 μm) was produced.

(Manufacture of all-Solid State Secondary Battery)

The negative electrode sheet No. c21 for an all-solid state secondary battery (the aluminum foil of the solid electrolyte-containing sheet No. 101 had been peeled off), which has the solid electrolyte layer obtained above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a positive electrode sheet (a positive electrode active material layer) punched out from the positive electrode sheet for an all-solid state secondary battery produced below into a disk shape having a diameter of 14.0 mm was overlaid on the solid electrolyte layer. A stainless steel foil (a positive electrode collector) was further layered thereon to form a laminate 12 for an all-solid state secondary battery (a laminate consisting of copper foil—negative electrode active material layer—solid electrolyte layer—positive electrode active material layer—aluminum foil—stainless steel foil). Then, the 2032-type coin case 11 was crimped to manufacture an all-solid state secondary battery No. 101 illustrated in FIG. 2.

An all-solid state secondary battery No. 102 was produced in the same manner as in the manufacture of the all-solid state secondary battery No. 101, except that in the manufacture of the all-solid state secondary battery No. 101, a solid electrolyte sheet No. 102 for an all-solid secondary battery was used instead of the solid electrolyte sheet No. 101 for an all-solid state secondary battery.

An all-solid state secondary battery No. 103 was manufactured as follows.

The positive electrode sheet No. 103 for an all-solid state secondary battery (the aluminum foil of the solid electrolyte-containing sheet had been peeled off), which includes the solid electrolyte layer obtained above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a lithium foil cut out in a disk shape having a diameter of 15 mm was overlaid on the solid electrolyte layer. A stainless steel foil was further layered thereon to form a laminate 12 for an all-solid state secondary battery (a laminate consisting of aluminum foil—positive electrode active material layer—solid electrolyte layer—lithium foil—stainless steel foil). Then, the 2032-type coin case 11 was crimped to manufacture an all-solid state secondary battery 13 of No. 103 illustrated in FIG. 2.

The all-solid state secondary battery manufactured in this manner has a layer configuration illustrated in FIG. 1 (however, the lithium foil corresponds to a negative electrode active material layer 2 and a negative electrode collector 1).

Each of all-solid state secondary battery Nos. 104 to 123 was manufactured in the same manner as in the manufacture of the all-solid state secondary battery No. 103, except that in the manufacture of the all-solid state secondary battery No. 103, a positive electrode sheet for an all-solid state secondary battery, which includes a solid electrolyte layer shown in the column of “Electrode active material layer (Sheet No.)” of Table 4-1, was used instead of the positive electrode No. 103 for a secondary battery, which has a solid electrolyte layer.

Next, an all-solid state secondary battery No. 124 having a layer configuration illustrated in FIG. 1 was produced as follows.

The negative electrode sheet No. 124 for an all-solid state secondary battery (the aluminum foil of the solid electrolyte-containing sheet had been peeled off), which has the solid electrolyte layer obtained above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a positive electrode sheet (a positive electrode active material layer) punched out from the positive electrode sheet for an all-solid state secondary battery produced below into a disk shape having a diameter of 14.0 mm was overlaid on the solid electrolyte layer. A stainless steel foil (a positive electrode collector) was further layered thereon to form a laminate 12 for an all-solid state secondary battery (a laminate consisting of copper foil—negative electrode active material layer—solid electrolyte layer—positive electrode active material layer—aluminum foil—stainless steel foil). Then, the 2032-type coin case 11 was crimped to manufacture an all-solid state secondary battery No. 124 illustrated in FIG. 2.

A positive electrode sheet for an all-solid state secondary battery to be used in the manufacture of the all-solid state secondary battery Nos. 101 and 124) was prepared as follows.

(Preparation of Positive Electrode Composition)

180 beads of zirconia beads having a diameter of 5 mm were put into a 45 mL container made of zirconia (manufactured by FRITSCH), 2.7 g of the LPS synthesized in the above Synthesis Example A, and 0.3 g of KYNAR FLEX 2500-20 (product name, PVdF-HFP: polyvinylidene fluoride—hexafluoropropylene copolymer, manufactured by Arkema S.A.) in terms of a solid content mass and 22 g of butyl butyrate were put into the above container. The container was set in a planetary ball mill P-7 (product name, manufactured by FRITSCH) and the components were stirred for 60 minutes at 25° C. and a rotation speed of 300 rpm. Then, 7.0 g of LiNi_{1/3}Co_{1/3}Mn_{1/3}O₂ (NMC) was put into the container as the positive electrode active material, and similarly, the container was set in a planetary ball mill P-7, mixing was continued at 25° C. and a rotation speed of 100 rpm for 5 minutes to prepare a positive electrode composition.

(Production of Positive Electrode Sheet for all-Solid State Secondary Battery)

The positive electrode composition obtained as described above was applied onto an aluminum foil (a positive electrode collector) having a thickness of 20 μm with a baker type applicator (product name: SA-201, manufactured by Tester Sangyo Co., Ltd.), heating was carried out at 100° C. for 2 hours to dry (to remove the dispersion medium) the positive electrode composition. Then, using a heat press machine, the dried positive electrode composition was pressurized (10 MPa, 1 minute) at 25° C. to produce each of positive electrode sheets for an all-solid state secondary battery, having a positive electrode active material layer having a film thickness of 80 μm.

Each of all-solid state secondary battery Nos. 125 to 144 and c101 to c110 was manufactured in the same manner as in the manufacture of the all-solid state secondary battery No. 124, except that in the manufacture of the all-solid state secondary battery No. 124, a negative electrode sheet for an all-solid state secondary battery, which includes a solid electrolyte layer shown in the column of “Electrode active material layer (Sheet No.)” of Table 4-2, was used instead of the negative electrode No. 124 for a secondary battery, which has a solid electrolyte layer.

The following evaluations were carried out for each of the manufactured all-solid state secondary battery, and the results are shown in Table 4-1 and Table 4-2 (collectively referred to as Table 4).

<Evaluation 5: Cycle Characteristics>

The discharge capacity retention rate of each of the all-solid state secondary batteries manufactured as described above was measured using a charging and discharging evaluation device TOSCAT-3000 (product name, manufactured by Toyo System Corporation).

Specifically, each of the all-solid state secondary batteries was charged in an environment of 25° C. at a current density of 0.1 mA/cm² until the battery voltage reached 3.6 V. Then, the battery was discharged at a current density of 0.1 mA/cm² until the battery voltage reached 2.5 V. One charging operation and one discharging operation were set as one cycle of charging and discharging, and 3 cycles of charging and discharging were repeated under the same conditions to carry out initialization. Then, the above charging and discharging cycle was repeated, and the discharge capacity of each of the all-solid state secondary batteries was measured at each time after the charging and discharging cycle was carried out with a charging and discharging evaluation device: TOSCAT-3000 (product name).

In a case where the discharge capacity (the initial discharge capacity) of the first charging and discharging cycle after initialization is set to 100%, the battery performance (the cycle characteristics) was evaluated by determining where the number of charging and discharging cycles in a case where the discharge capacity retention rate (the discharge capacity with respect to the initial discharge capacity) reaches 80% was included in any of the following evaluation standards. In this test, the larger the number of cycles is, the better the battery performance (the cycle characteristics) is, and the initial battery performance can be maintained even in a case where a plurality of times of charging and discharging are repeated (even in a case of the long-term use). In this test, an evaluation standard of “D” or higher is the pass level.

All of the all-solid state secondary batteries according to the embodiment of the present invention exhibited initial discharge capacity values sufficient for functioning as an all-solid state secondary battery.

—Evaluation Standards—

A: 500 cycles or more

B: 300 cycles or more and less than 500 cycles

C: 150 cycles or more and less than 300 cycles

D: 80 cycles or more and less than 150 cycles

E: Less than 80 cycles

<Evaluation 6: Ion Conductivity>

The ion conductivity of each of the manufactured all-solid state secondary batteries was measured. Specifically, the alternating-current impedance of each of the all-solid state secondary batteries was measured in a constant-temperature tank (30° C.) using a 1255B FREQUENCY RESPONSE ANALYZER (product name, manufactured by SOLARTRON Analytical) at a voltage magnitude of 5 mV and a frequency of 1 MHz to 1 Hz. From the measurement result, the resistance of the sample for measuring ion conductivity in the layer thickness direction was determined, and the ion conductivity was determined by the calculation according to Expression (1).

Ion conductivity σ (mS/cm)=1,000×sample layer thickness (cm)/[resistance (Ω)×sample area (cm²)] Expression (1):

In Expression (1), the sample layer thickness is a value obtained by measuring the thickness before placing the laminate 12 in the 2032-type coin case 11 and subtracting the thickness of the collector (the total layer thickness of the solid electrolyte layer and the electrode active material layer). The sample area is the area of the disk-shaped sheet having a diameter of 14.5 mm.

It was determined where the obtained ion conductivity a was included in any of the following evaluation standards.

In this test, in a case where the evaluation standard is “D” or higher, the ion conductivity a is the pass level.

—Evaluation Standards—

A: 1.0≤σ

B: 0.9≤σ<1.0

C: 0.8≤σ<0.9

D: 0.6≤σ6<0.8

E: σ≤0.6

TABLE 4

| | Layer configuration | | | | |
|---|---|---|---|---|---|
| | Electrode active | Solid | | | |
| Battery | material layer | electrolyte layer | Cycle | Ion | |
| No. | (sheet No.) | (sheet No.) | characteristics | conductivity | Note |
| 101 | c21 | 101 | D | C | Present invention |
| 102 | c21 | 102 | A | A | Present invention |
| 103 | 103 | c11 | D | C | Present invention |
| 104 | 104 | c11 | D | C | Present invention |
| 105 | 105 | c11 | D | C | Present invention |
| 106 | 106 | c11 | D | C | Present invention |
| 107 | 107 | c11 | D | C | Present invention |
| 108 | 108 | c11 | D | C | Present invention |
| 109 | 109 | c11 | D | C | Present invention |
| 110 | 110 | c11 | C | C | Present invention |
| 111 | 111 | c11 | B | B | Present invention |
| 112 | 112 | c11 | B | B | Present invention |
| 113 | 113 | c11 | A | A | Present invention |
| 114 | 114 | c11 | A | A | Present invention |
| 115 | 115 | c11 | B | B | Present invention |
| 116 | 116 | c11 | B | B | Present invention |
| 117 | 117 | c11 | B | B | Present invention |
| 118 | 118 | c11 | D | C | Present invention |
| 119 | 119 | c11 | D | C | Present invention |
| 120 | 120 | c11 | D | C | Present invention |
| 121 | 121 | c11 | D | C | Present invention |
| 122 | 122 | c11 | D | C | Present invention |
| 123 | 123 | c11 | B | A | Present invention |
| 124 | 124 | c11 | D | C | Present invention |
| 125 | 125 | c11 | D | C | Present invention |
| 126 | 126 | c11 | D | C | Present invention |
| 127 | 127 | c11 | D | C | Present invention |
| 128 | 128 | c11 | D | C | Present invention |
| 129 | 129 | c11 | D | C | Present invention |
| 130 | 130 | c11 | D | C | Present invention |
| 131 | 131 | c11 | C | C | Present invention |
| 132 | 132 | c11 | B | B | Present invention |
| 133 | 133 | c11 | B | B | Present invention |
| 134 | 134 | c11 | A | A | Present invention |
| 135 | 135 | c11 | A | A | Present invention |
| 136 | 136 | c11 | B | B | Present invention |
| 137 | 137 | c11 | B | B | Present invention |
| 138 | 138 | c11 | B | B | Present invention |
| 139 | 139 | c11 | D | C | Present invention |
| 140 | 140 | c11 | D | C | Present invention |
| 141 | 141 | c11 | D | C | Present invention |
| 142 | 142 | c11 | D | C | Present invention |
| 143 | 143 | c11 | D | C | Present invention |
| 144 | 144 | c11 | A | A | Present invention |
| c101 | c21 | c11 | D | E | Comparative Example |
| c102 | c22 | c12 | E | D | Comparative Example |
| c103 | c23 | c13 | D | E | Comparative Example |
| c104 | c24 | c14 | D | E | Comparative Example |
| c105 | c25 | c15 | E | E | Comparative Example |
| c106 | c26 | c16 | E | E | Comparative Example |
| c107 | c27 | c17 | E | E | Comparative Example |
| c108 | c28 | c18 | D | E | Comparative Example |
| c109 | c29 | c19 | E | E | Comparative Example |
| c110 | c30 | c20 | D | E | Comparative Example |

The following findings can be seen from the results of Table 3 and Table 4.

All of the inorganic solid electrolyte-containing compositions, which do not contain the polymer binder defined in the present invention shown in Comparative Examples KC-1 to KC-10 and NKC-1 to NKC-10, are inferior in any one dispersibility, the effect of suppressing the deterioration of the inorganic solid electrolyte of the produced sheet for an all-solid state secondary battery, and the ion conductivity (the interface resistance) in a low temperature environment. In addition, the negative electrode sheets produced by using the negative electrode compositions NKC-1 and NKC-5 to NKC-10 do not have sufficient adhesiveness to the collector. Furthermore, the all-solid state secondary batteries of Comparative Examples c101 to c110 manufactured by using KC-1 to KC-10 and NKC-1 to NKC-10, respectively, cannot compatibly achieve cycle characteristics and ion conductivity.

On the other hand, the inorganic solid electrolyte-containing compositions that contain the polymer binder defined in the present invention, which are shown in K-1, K-2, PK-1 to PK-21, and NK-1 to NK-21 of the present invention, have both dispersibility, the effect of suppressing the deterioration of the inorganic solid electrolyte, and the ion conductivity (the interface resistance) in a low temperature environment. In addition, since the electrode compositions PK-1 to PK-21 and NK-1 to NK-21 are used in the formation of the active material layer of the all-solid state secondary battery, the adhesiveness of the collector to an electrode sheet to be obtained can be made firm. Furthermore, it can be seen that an all-solid state secondary battery including a constitutional layer formed of each of these inorganic solid electrolyte-containing compositions can realize a high ion conductivity and excellent cycle characteristics.

It is noted that the deterioration test of the above-described inorganic solid electrolyte due to moisture was evaluated using a sheet for an all-solid state secondary battery, which is most concerned about contact with moisture in an actual manufacturing process. A similar effect can be expected even in an inorganic solid electrolyte-containing composition in which the inorganic solid electrolyte and the polymer binder defined in the present invention are present together and furthermore, in a constitutional layer incorporated into the all-solid state secondary battery, as long as they exhibit the effect of suppressing the deterioration of the inorganic solid electrolyte in the sheet for an all-solid state secondary battery.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
11: 2032-type coin case
12: laminate for an all-solid state secondary battery
13: coin-type all-solid state secondary battery

What is claimed is:

1. An inorganic solid electrolyte-containing composition comprising:
an inorganic solid electrolyte having an ion conductivity of a metal belonging to Group 1 or Group 2 in the periodic table;
a polymer binder; and
a dispersion medium,
wherein the polymer binder contains a polymer having a surface energy of 20 mN/m or less and an SP value of 14 to 21.5 MPa^{1/2} and is dissolved in the dispersion medium.

2. The inorganic solid electrolyte-containing composition according to claim 1,
wherein the polymer has an elastic modulus of 1 MPa or more.

3. The inorganic solid electrolyte-containing composition according to claim 1,
wherein the polymer has a constitutional component represented by Formula (LF) or Formula (LS) in a main chain or a side chain, 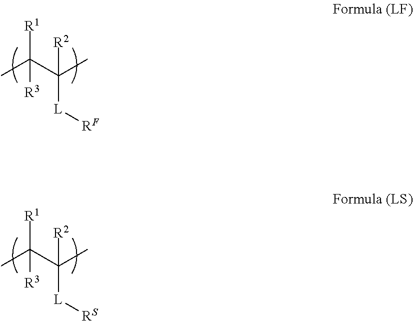
in Formula (LF) or Formula (LS), R¹ to R³ represent a hydrogen atom or a substituent,
L represents a single bond or a linking group,
R^{F} represents a substituent containing a carbon atom and a fluorine atom, and
R^{S} represents a substituent containing a silicon atom.

4. The inorganic solid electrolyte-containing composition according to claim 1,
wherein the polymer is a graft polymer.

5. The inorganic solid electrolyte-containing composition according to claim 1,
wherein a main chain of the polymer is a block polymer.

6. The inorganic solid electrolyte-containing composition according to claim 1,
wherein the dispersion medium has an SP value of 14 to 24 MPa^{1/2}.

7. The inorganic solid electrolyte-containing composition according to claim 1, further comprising an active material.

8. The inorganic solid electrolyte-containing composition according to claim 1, further comprising a conductive auxiliary agent.

9. The inorganic solid electrolyte-containing composition according to claim 1,
wherein the inorganic solid electrolyte is a sulfide-based inorganic solid electrolyte.

10. A sheet for an all-solid state secondary battery, comprising a layer formed of the inorganic solid electrolyte-containing composition according to claim 1.

11. An all-solid state secondary battery comprising, in the following order:
a positive electrode active material layer;
a solid electrolyte layer; and
a negative electrode active material layer,
wherein at least one layer of the positive electrode active material layer, the solid electrolyte layer, or the negative electrode active material layer is a layer formed of the inorganic solid electrolyte-containing composition according to claim 1.

12. A manufacturing method for a sheet for an all-solid state secondary battery, the manufacturing method comprising forming a film of the inorganic solid electrolyte-containing composition according to claim 1.

13. A manufacturing method for an all-solid state secondary battery, the manufacturing method comprising manufacturing an all-solid state secondary battery through the manufacturing method according to claim 12.
